(19) United States
(12) Patent Application Publication
(10) Pub. No.: US 2026/0343450 A1
(43) Pub. Date: Oct. 29, 2026

(54) multiple TA valueS IN multiple-TRP scenarioS in a wireless communication system

(71) Applicant: GOOGLE LLC, Mountain View, CA (US)

(72) Inventors: Chih-Hsiang Wu, Taoyuan City (TW); Jia-Hong Liou, Mountain View, CA (US)

(21) Appl. No.: 19/099,729

(22) PCT Filed: Jul. 29, 2023
(86) PCT No.: PCT/US2023/029052

§ 371 Date: Jan. 29, 2025

Related U.S. Application Data
(60) Provisional application No. 63/393,814, filed on Jul. 29, 2022.

(51) Int. Cl. H04W 56/00; H04L 5/00

(52) U.S. Cl. CPC H04W 56/0045; H04L 5/0053

(57) ABSTRACT

A method in a user equipment (UE) comprises receiving (906), from a radio access network (RAN), a configuration including a first timing advance (TA) value and a second TA value for use in a serving cell; receiving (908), from the RAN, a spatial indication for communicating a signal between the UE and the RAN; selecting (914) a TA value from among the first TA value and the second TA value based on the spatial indication; and communicate (922, 926) the signal with the RAN using the selected TA value.

### CROSS-REFERENCE TO RELATED APPLICATION

This application claims priority to and the benefit of the filing date of provisional U.S. Patent Application No. 63/393,814 entitled “ENABLING MULTIPLE TA VALUES IN MULTIPLE-TRP SCENARIOS IN A WIRELESS COMMUNICATION SYSTEM,” filed on Jul. 29, 2022. The entire contents of the provisional application are hereby expressly incorporated herein by reference.

### FIELD OF THE DISCLOSURE

This disclosure relates generally to wireless communications and, more particularly, to using multiple TA values in a serving cell at UE side or NW/Base Station (BS) side. The techniques can apply to multiple-transmit-and/or-receive-points (M-TRP) scenarios.

### BACKGROUND

This background description is provided for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Generally speaking, a base station operating a cellular radio access network (RAN) communicates with a user equipment (UE) using a certain radio access technology (RAT) and multiple layers of a protocol stack. For example, the physical layer (PHY) of a RAT provides transport channels to the Medium Access Control (MAC) sublayer, which in turn provides logical channels to the Radio Link Control (RLC) sublayer, and the RLC sublayer in turn provides data transfer services to the Packet Data Convergence Protocol (PDCP) sublayer. The Radio Resource Control (RRC) sublayer is disposed above the PDCP sublayer.

The RRC sublayer specifies the RRC_IDLE state, in which a UE does not have an active radio connection with a base station; the RRC_CONNECTED state, in which the UE has an active radio connection with the base station; and the RRC_INACTIVE state to allow a UE to more quickly transition back to the RRC_CONNECTED state due to Radio Access Network (RAN)-level base station coordination and RAN-paging procedures. In some cases, the UE in the RRC_IDLE or RRC_INACTIVE state has only one, relatively small packet to transmit. In some such cases, the UE in the RRC_IDLE or RRC_INACTIVE state performs an early data transmission without transitioning to the RRC_CONNECTED state.

Regarding the PHY layer, in some cases, different channel or reference signal (RS) configurations correspond to different beam indication techniques. For most DL transmissions (e.g., physical downlink shared channel (PDSCH), physical downlink control channel (PDCCH), or channel state information (CSI) resource signal (CSI-RS)), a transmission configuration indication (TCI) framework and TCI states are applicable and configured for such transmissions. However, in some cases, PDCCH transmissions need a MAC-CE to further indicate a TCI state within the configured TCI states, and PDSCH transmissions similarly need a MAC-CE and downlink control information (DCI) for such. For a physical uplink shared channel (PUSCH), the UL beam indication relies on the index of a sounding reference signal (SRS) resource on which the UE has transmitted at least once. In some cases, for a physical uplink control channel (PUCCH), a MAC-CE indicates spatial relation for a UE to derive a UL beam. Further, a spatial relation sometimes is also configured in an SRS resource set, which indicates the same UL beam as applicable for all SRS resources in the SRS resource set. However, these messages result in a large signaling overhead when many channels or RSs share the same beam.

### SUMMARY

An example embodiment of the techniques of this disclosure is a method in a UE. The method comprises receiving, from a RAN, a configuration including a first timing advance (TA) value and a second TA value for use in a serving cell; receiving, from the RAN, a spatial indication for communicating a signal between the UE and the RAN; selecting a TA value from among the first TA value and the second TA value based on the spatial indication; and communicating the signal with the RAN using the selected TA value.

Another example embodiment of these techniques is a method in a RAN. The method comprises transmitting, to a UE, a configuration including a first timing advance (TA) value and a second TA value for use in a serving cell; transmitting (564), from the RAN, a spatial indication for communicating a signal between the UE and the RAN, the spatial indication associated with one of the first TA value or the second TA value; and communicating (576) the signal with the UE in accordance with the spatial indication.

Yet another example embodiment of these techniques is an apparatus comprising a transceiver configured to communicate with a radio interface; and processing hardware configured to implement one of the methods above.

### BRIEF DESCRIPTION OF THE DRAWINGS

FIG. 1A is a block diagram of an example system in which a distributed base station and/or a user equipment (UE) can implement the techniques of this disclosure;

FIG. 1B is a block diagram of an example base station including a central unit (CU) and a distributed unit (DU) of a distributed base station that can operate in the system of FIG. 1A;

FIG. 2A is a block diagram of an example protocol stack according to which the UE of FIGS. 1A-B can communicate with base stations;

FIG. 2B is a block diagram of an example protocol stack according to which the UE of FIGS. 1A-B can communicate with a DU and a CU of a base station; and

FIG. 3A is a block diagram of a detailed structure of various sublayers of a protocol stack as depicted in FIGS. 2A and/or 2B, including a scheduling and/or priority handling function;

FIG. 3B is a block diagram of a detailed structure of various sublayers of a protocol stack, similar to FIG. 3A, but in which the structure includes a logical channel prioritization function;

FIG. 4A is a block diagram of a HARQ entity including a plurality of HARQ processes and communicating with a transport channel to a plurality of TRPs;

FIG. 4B is a block diagram of a HARQ entity similar to that of FIG. 4A, but in which the HARQ entity includes a plurality of HARQ process groups associated with a plurality of transport channels to a plurality of TRPs;

FIG. 4C is a block diagram of a HARQ entity similar to that of FIG. 4A, but in which the HARQ entity communicates with a single TRP;

FIG. 5A is a messaging diagram of an example scenario in which a UE synchronizes with a first TRP and/or a second TRP for performing communications with a base station;

FIG. 5B is a messaging diagram of an example scenario similar to FIG. 5A, but in which the UE receives UL and DL configuration parameters in separate radio resource configuration messages;

FIG. 5C is a messaging diagram of an example scenario similar to FIG. 5A, but in which the base station transmits the UL configuration parameters to the UE via the second TRP rather than the first TRP;

FIG. 5D is a messaging diagram of an example scenario similar to FIG. 5A, but in which the UE receives a response from the base station while performing a random access procedure via the first TRP rather than via the second TRP;

FIG. 5E is a messaging diagram of an example scenario similar to FIG. 5A, but in which the UE receives the PDCCH order via the first TRP rather than the second TRP;

FIG. 6 is a flow diagram of an example method in which a UE of FIGS. 1A and/or 1B determines whether to transmit a UL transmission to a base station using a first or second TA value based on with which TA value the UL transmission is associated;

FIG. 7 is a flow diagram of an example method similar to FIG. 6, but in which the UE determines whether to transmit the UL transmission using the first or second TA value based on whether the configuration for the UL transmission includes a first or second index;

FIG. 8 is a flow diagram of an example method similar to FIG. 6, but in which the UE determines whether to transmit the UL transmission using the first or second TA value based on whether a CORESET is associated with a first or second index;

FIG. 9A is a flow diagram of an example method similar to FIG. 6, but in which the UE determines whether to transmit the UL transmission using the first or second TA value based on whether a spatial indication is associated with a first or second index;

FIG. 9B is a flow diagram of an example method similar to FIG. 9A, but in which the UE determines whether to transmit the UL transmission using the first or second TA value based on whether a reference signal is associated with a first or second index;

FIG. 10 is a flow diagram of an example method similar to FIG. 6, but in which the UE determines whether to transmit the UL transmission using the first or second TA value based on whether a pathloss reference signal is associated with a first or second index;

FIG. 11 is a flow diagram of an example method similar to FIG. 6, but in which the UE determines whether to transmit the UL transmission using the first or second TA value based on whether the UL transmission is included in a first or second group; and

FIG. 12 is a flow diagram of an example method similar to FIG. 6, but in which the UE determines whether to transmit the UL transmission using the first or second TA value based on whether a HARQ process is included in a first or second set of HARQ processes.

### DETAILED DESCRIPTION OF THE DRAWINGS

The techniques discussed below apply at least to M-TRP scenarios that involve multiple timing advance (TA) values, where a UE maintains multiple TA values in at least one serving cell. The approaches discussed below allow devices to correctly associate a channel or a reference signal (RS) with a TA value, so that a UE determines which TA value to apply for a UL transmission (e.g., an RS transmission). These techniques also allow a UE to report a capability with respect to supporting multiple TA values.

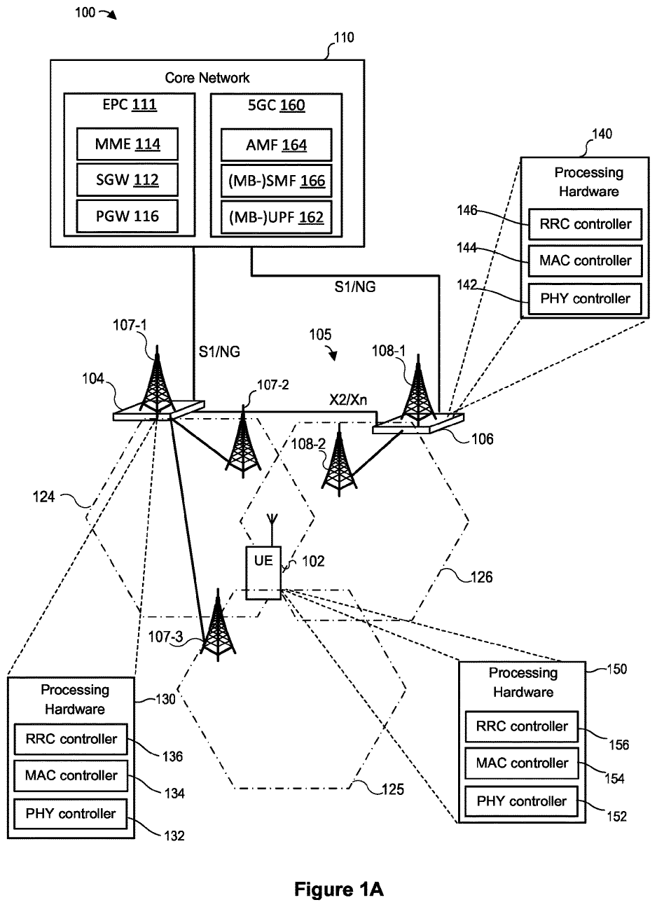

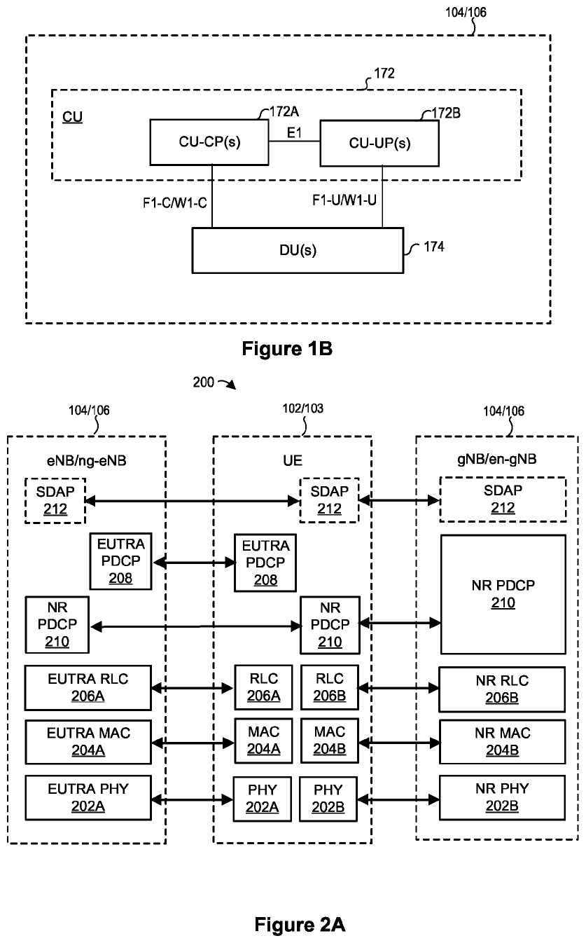

Referring first to FIG. 1A, an example wireless communication system 100 includes a UE 102, a base station (BS) 104, a base station 106, and a core network (CN) 110. The base stations 104 and 106 can operate in a RAN 105 connected to the core network (CN) 110. The CN 110 can be implemented as an evolved packet core (EPC) 111 or a fifth generation (5G) core (5GC) 160, for example. The CN 110 can also be implemented as a sixth generation (6G) core in another example.

The base station 104 can cover one or more cells (e.g., cells 124 and 125) with one or more transmit and/or receive points (TRPs), and the base station 106 can similarly cover one or more cells (e.g., cell 126) with one or more TRPs. For example, the base station 104 operates cell 124 with TRPs 107-1 and 107-2 and operates cell 125 with TRP 107-3, and the base station 106 operates cell 126 with TRPs 108-1 and 108-2. The cells 124 and 125 are operated on the same carrier frequency/frequencies. The cell 126 can be operated on the same carrier frequency/frequencies as the cells 124 and 125. Alternatively, the cell 126 can be operated on different carrier frequency/frequencies from the cells 124 and 125. In some implementations, the base station 104 connects each of the TRPs 107-1, 107-2 and 107-3 via a fiber connection or an Ethernet connection. If the base station 104 is a gNB, the cells 124 and 125 are NR cells. If the base station 104 is an (ng-)eNB, the cells 124 and 125 are evolved universal terrestrial radio access (EUTRA) cells. Similarly, if the base station 106 is a gNB, the cell 126 is an NR cell, and if the base station 106 is an (ng-)eNB, the cell 126 is an EUTRA cell. The cells 124, 125, and 126 can be in the same Radio Access Network Notification Areas (RNA) or different RNAs. In general, the RAN 105 can include any number of base stations, and each of the base stations can cover one, two, three, or any other suitable number of cells. The UE 102 can support at least a 5G NR (or simply, “NR”) or E-UTRA air interface to communicate with the base station 104 via the TRP 107-1, TRP 107-2 and/or TRP-3. Similarly, the UE 102 can support at least a 5G NR (or simply, “NR”) or E-UTRA air interface to communicate with the base station 106 via the TRP 108-1 and/or TRP 108-2. Each of the base stations 104, 106 can connect to the CN 110 via an interface (e.g., S1 or NG interface). The base stations 104 and 106 also can be interconnected via an interface (e.g., X2 or Xn interface) for interconnecting NG RAN nodes.

When a base station (e.g., the base station 104 or 106) transmits DL data via a TRP (e.g., the TRP 107-1, TRP 107-2, TRP 107-3, TRP 108-1 or TRP 108-2), the base station 104 can generate a packet including the data transmit the packet to the TRP 107-1. For example, the packet can be a fronthaul transport protocol data unit. The TRP extracts the data from the packet and transmits the data. In some implementations, the base station 104 can include control information for time-critical control and management information directly related to the data in the packet, and the TRP can transmit the data in accordance with the control information. In some implementations, the data includes In-phase and Quadrature (IQ) data, a physical layer bit sequence, or a MAC PDU. When the TRP receives data from a UE (e.g., UE 102), the TRP generates a packet including the data and transmit the packet to the base station 104. In some implementations, the data includes IQ data, a physical layer bit sequence, or a MAC PDU.

Among other components, the EPC 111 can include a Serving Gateway (SGW) 112, a Mobility Management Entity (MME) 114, and a Packet Data Network Gateway (PGW) 116. The SGW 112 in general is configured to transfer user-plane packets related to audio calls, video calls, Internet traffic, etc., and the MME 114 is configured to manage authentication, registration, paging, and other related functions. The PGW 116 provides connectivity from the UE 102 to one or more external packet data networks, e.g., an Internet network and/or an Internet Protocol (IP) Multimedia Subsystem (IMS) network. The 5GC 160 includes a User Plane Function (UPF) 162 and an Access and Mobility Management Function (AMF) 164, and/or Session Management Function (SMF) 166. Generally, the UPF 162 is configured to transfer user-plane packets related to audio calls, video calls, Internet traffic, etc., the AMF 164 is configured to manage authentication, registration, paging, and other related functions, and the SMF 166 is configured to manage PDU sessions.

As illustrated in FIG. 1A, the base station 104 supports cells 124 and 125, and the base station 106 supports a cell 126. The cells 124, 125, and 126 can partially overlap, so that the UE 102 can select, reselect, or hand over from one of the cells 124, 125, and 126 to another. To directly exchange messages or information, the base station 104 and base station 106 can support an X2 or Xn interface. In general, the CN 110 can connect to any suitable number of base stations supporting NR cells and/or EUTRA cells.

The base station 104 is equipped with processing hardware 130 that can include one or more general-purpose processors (e.g., CPUs) and a non-transitory computer-readable memory storing instructions that the one or more general-purpose processors execute. Additionally or alternatively, the processing hardware 130 can include special-purpose processing units. The processing hardware 130 can include a PHY controller 132 configured to transmit data and control signal on physical DL channels and DL reference signals with one or more user devices (e.g., UE 102) via one or more TRPs (e.g., TRP 107-1, TRP 107-2 and/or TRP 107-3). The PHY controller 132 is also configured to receive data and control signal on physical UL channels and/or UL reference signals with the one or more user devices via the one or more TRPs (e.g., TRP 107-1, TRP 107-2 and/or TRP 107-3). The processing hardware 130 in an example implementation includes a MAC controller 134 configured to perform a random access (RA) procedure with one or more user devices, manage UL timing advance for the one or more user devices, receive UL MAC PDUs from the one or more user devices, and transmit DL MAC PDUs to the one or more user devices. The processing hardware 130 can further include an RRC controller 136 to implement procedures and messaging at the RRC sublayer of the protocol communication stack. The base station 106 can include processing hardware 140 that is similar to processing hardware 130. In particular, components 142, 144, and 146 can be similar to the components 132, 134, and 136, respectively.

The UE 102 is equipped with processing hardware 150 that can include one or more general-purpose processors such as CPUs and non-transitory computer-readable memory storing machine-readable instructions executable on the one or more general-purpose processors, and/or special-purpose processing units. The PHY controller 152 is also configured to receive data and control signal on physical DL channels and/or DL reference signals with the base station 104 or 106 via one or more TRPs (e.g., TRP 107-1, TRP 107-2, TRP 107-3, TRP 108-1 and/or TRP 108-2). The PHY controller 152 is also configured to transmit data and control signal on physical UL channels and/or UL reference signals with the base station 104 or 106 via the one or more TRPs (e.g., TRP 107-1, TRP 107-2, TRP 107-3, TRP 108-1 and/or TRP 108-2). The processing hardware 150 in an example implementation includes a MAC controller 154 configured to perform a random access procedure with base station 104 or 106, manage UL timing advance for the one or more user devices, transmit UL MAC PDUs to the base station 104 or 106, and receive DL MAC PDUs from the base station 104 or 106. The processing hardware 150 can further include an RRC controller 156 to implement procedures and messaging at the RRC sublayer of the protocol communication stack.

FIG. 1B depicts an example distributed or disaggregated implementation of one or both of the base stations 104, 106. In this implementation, each of the base station 104 and/or 106 includes a central unit (CU) 172 and one or more distributed units (DUs) 174. The CU 172 includes processing hardware, such as one or more general-purpose processors (e.g., CPUs) and a computer-readable memory storing machine-readable instructions executable on the general-purpose processor(s), and/or special-purpose processing units. For example, the CU 172 can include a PDCP controller (e.g., PDCP controller 134, 144), an RRC controller (e.g., RRC controller 136, 146), and/or an RRC inactive controller (e.g., RRC inactive controller 138, 148). In some implementations, the CU 172 can include an RLC controller configured to manage or control one or more RLC operations or procedures. In other implementations, the CU 172 does not include an RLC controller.

Each of the DUs 174 also includes processing hardware that can include one or more general-purpose processors (e.g., CPUs) and computer-readable memory storing machine-readable instructions executable on the one or more general-purpose processors, and/or special-purpose processing units. For example, the processing hardware can include a MAC controller (e.g., MAC controller 132, 142) configured to manage or control one or more MAC operations or procedures (e.g., a random access procedure), and/or an RLC controller configured to manage or control one or more RLC operations or procedures. The processing hardware can also include a physical layer controller configured to manage or control one or more physical layer operations or procedures.

In some implementations, the RAN 105 supports Integrated Access and Backhaul (IAB) functionality. In some implementations, the DU 174 operates as an (IAB)-node, and the CU 172 operates as an IAB-donor.

In some implementations, the CU 172 can include a logical node CU-CP 172A that hosts the control plane part of the PDCP protocol of the CU 172. The CU 172 can also include logical node(s) CU-UP 172B that hosts the user plane part of the PDCP protocol and/or SDAP protocol of the CU 172. The CU-CP 172A can transmit control information (e.g., RRC messages, F1 application protocol messages), and the CU-UP 172B can transmit data packets (e.g., SDAP PDUs or IP packets).

The CU-CP 172A can be connected to multiple CU-UPs 172B through the E1 interface. The CU-CP 172A selects the appropriate CU-UP 172B for the requested services for the UE 102. In some implementations, a single CU-UP 172B can be connected to multiple CU-CPs 172A through the E1 interface. If the CU-CP 172A and DU(s) 174 belong to a gNB, the CU-CP 172A can be connected to one or more DU 174s through an F1-C interface and/or an F1-U interface. If the CU-CP 172A and DU(s) 174 belong to an ng-cNB, the CU-CP 172A can be connected to DU(s) 174 through a W1-C interface and/or a W1-U interface. In some implementations, one DU 174 can be connected to multiple CU-UPs 172B under the control of the same CU-CP 172A. In such implementations, the connectivity between a CU-UP 172B and a DU 174 is established by the CU-CP 172A using Bearer Context Management functions.

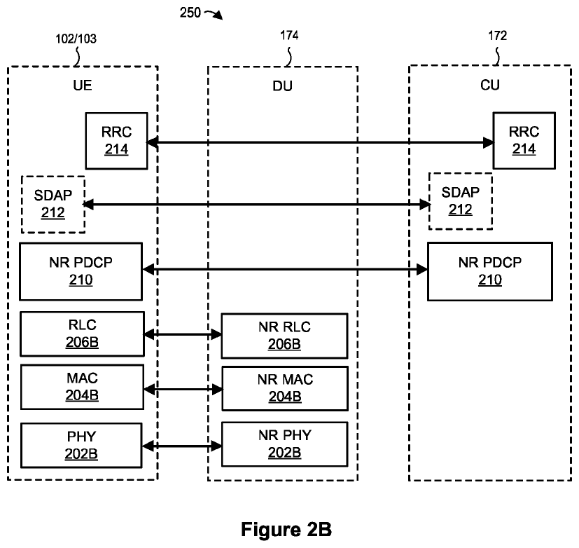

FIG. 2A illustrates, in a simplified manner, an example protocol stack 200 according to which the UE 102 can communicate with an eNB/ng-eNB or a gNB (e.g., one or both of the base stations 104, 106).

In the example stack 200, a physical layer (PHY) 202A of EUTRA provides transport channels to the EUTRA MAC sublayer 204A, which in turn provides logical channels to the EUTRA RLC sublayer 206A. The EUTRA RLC sublayer 206A in turn provides RLC channels to a EUTRA PDCP sublayer 208 and, in some cases, to an NR PDCP sublayer 210. Similarly, the NR PHY 202B provides transport channels to the NR MAC sublayer 204B, which in turn provides logical channels to the NR RLC sublayer 206B. The NR RLC sublayer 206B in turn provides data transfer services to the NR PDCP sublayer 210. The NR PDCP sublayer 210 in turn can provide data transfer services to the SDAP sublayer 212 or an RRC sublayer (not shown in FIG. 2A). The UE 102, in some implementations, supports both the EUTRA and the NR stack as shown in FIG. 2A, to support handover between EUTRA and NR base stations and/or to support dual connectivity (DC) over EUTRA and NR interfaces. Further, as illustrated in FIG. 2A, the UE 102 can support layering of NR PDCP 210 over EUTRA RLC 206A, and SDAP sublayer 212 over the NR PDCP sublayer 210.

The EUTRA PDCP sublayer 208 and the NR PDCP sublayer 210 receive packets (e.g., from an IP layer, layered directly or indirectly over the PDCP layer 208 or 210) that can be referred to as SDUs, and output packets (e.g., to the RLC layer 206A or 206B) that can be referred to as PDUs. Except where the difference between SDUs and PDUs is relevant, this disclosure for simplicity refers to both SDUs and PDUs as “packets.”

On a control plane, the EUTRA PDCP sublayer 208 and the NR PDCP sublayer 210 can provide signaling radio bearers (SRBs) to the RRC sublayer (not shown in FIG. 2A) to exchange RRC messages or NAS messages, for example. On a user plane, the EUTRA PDCP sublayer 208 and the NR PDCP sublayer 210 can provide data radio bearers (DRBs) to support data exchange. Data exchanged on the NR PDCP sublayer 210 can be SDAP PDUs, IP packets, or Ethernet packets.

Thus, it is possible to functionally split the radio protocol stack, as shown by the radio protocol stack 250 in FIG. 2B. The CU at one or both of the base stations 104, 106 can hold all the control and upper layer functionalities (e.g., RRC 214, SDAP 212, NR PDCP 210), while the lower layer operations (e.g., NR RLC 206B, NR MAC 204B, and NR PHY 202B) are delegated to the DU. To support connection to a 5GC, NR PDCP 210 provides SRBs to RRC 214, and NR PDCP 210 provides DRBs to SDAP 212 and SRBs to RRC 214.

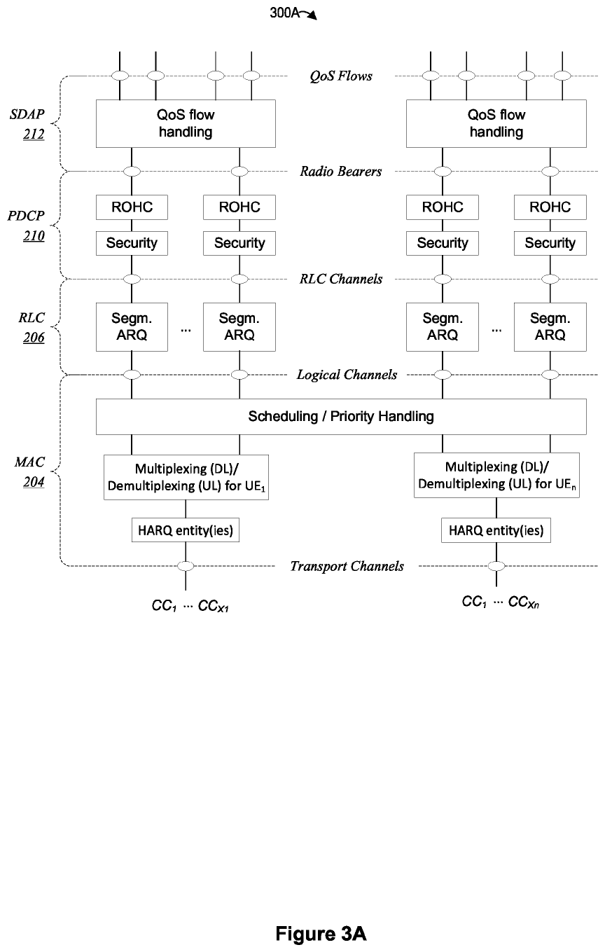

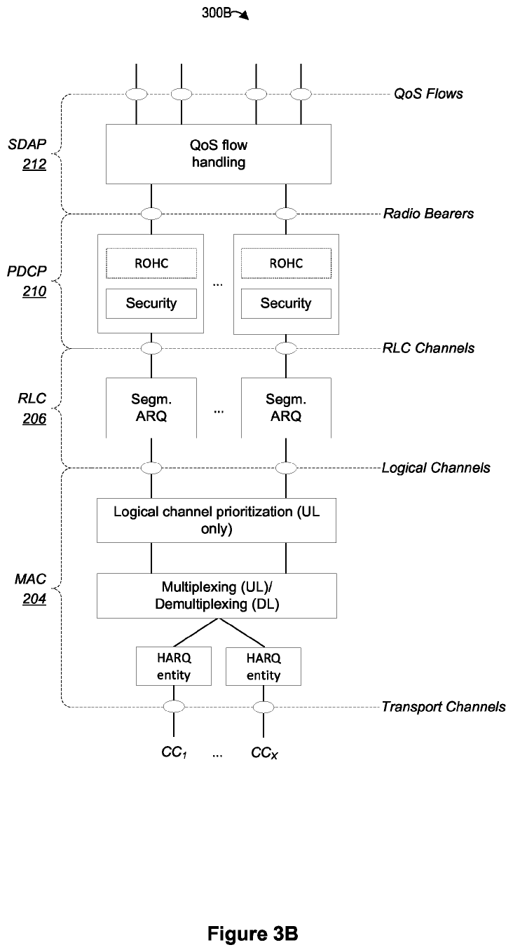

FIG. 3A illustrates a detailed structure 300A of the NR layer 2 protocol stack 200 or 250 for the base station 104 or 106. The PHY 202 (not shown in FIG. 3A) provides transport channels to the MAC sublayer 204. The MAC sublayer 204 includes a scheduling and/or priority handling function for scheduling and/or prioritizing DL and UL transmissions with one or more user devices. The MAC sublayer 204 also includes a multiplexing function for DL transmission and/or a demultiplexing function for UL transmission with a particular user device. The MAC sublayer 204 further includes Hybrid Automatic Repeat reQuest (HARQ) entities each for DL transmissions and/or UL transmissions on a particular DL component carrier (CC) and/or a particular UL CC with a particular user device. The RLC sublayer 206 includes segmentation and Automatic Repeat reQuest (ARQ) functions for DL data and UL data communicated with one or more UEs. The PDCP sublayer 210 provides radio bearers to the SDAP sublayer 212 and includes (i) security and (ii) robust header compression (ROHC) functions for (i) integrity protection and/or encryption/description and (ii) header compression/decompression, respectively. The SDAP sublayer 212 provides 5GC QoS flows to upper layer(s).

FIG. 3B illustrates a detailed structure 300B of the NR layer 2 protocol stack 200 or 250 for the UE 102, similar to structure 300A. The PHY 202 (not shown in FIG. 3B) provides, to the MAC sublayer 204, transport channels for DL and UL transmission with the base station(s) 104 or 106. The MAC sublayer 204 includes one or more HARQ entities each for DL transmissions and/or UL transmissions on a particular DL CC and/or a particular UL CC with the base station(s) 104 or 106. The MAC sublayer 204 also includes logical channel prioritization and multiplexing functions for UL transmission to the base station(s) 104 or 106 and includes a demultiplexing function for DL transmission from the base station(s) 104 or 106. The RLC sublayer 206 includes segmentation and Automatic Repeat reQuest (ARQ) functions for DL data and UL data communicated with the base station(s) 104 and/or 106. The PDCP sublayer 210 provides radio bearers to the SDAP sublayer 212 and includes (i) security and (ii) robust header compression (ROHC) functions for (i) integrity protection and/or encryption/description and (ii) header compression/decompression, respectively. The SDAP sublayer 212 provides 5GC QoS flows to upper layer(s).

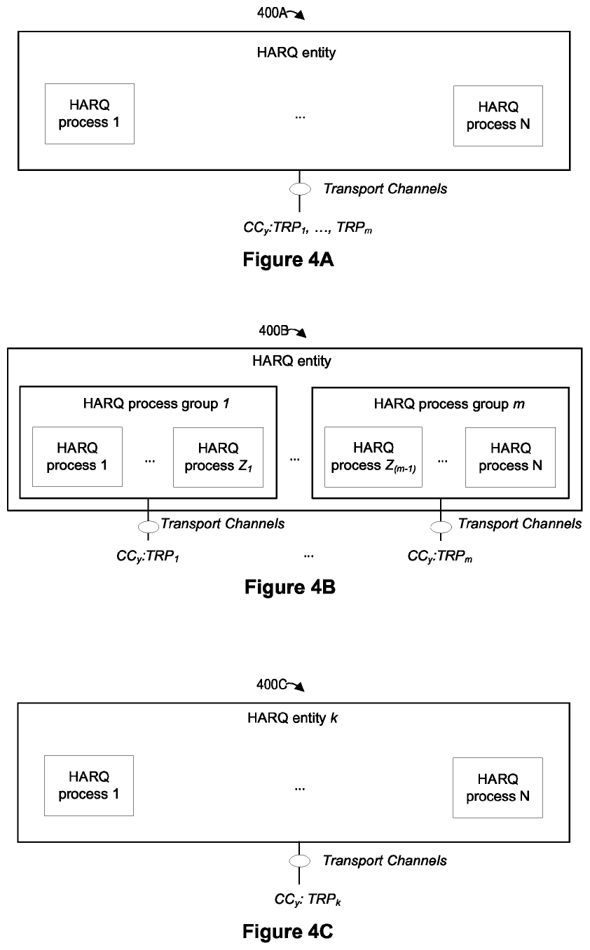

FIGS. 4A-4C illustrate different implementations of a HARQ entity for multiple TRP (mTRP) operation on a particular CCy (e.g., UL CC or DL CC), which can be implemented in the UE 102, the base station 104 or 106, or the DU 174 of the base station 104 or 106.

Referring first to FIG. 4A which depicts a HARQ entity 400A. In some implementations, the HARQ entity 400A includes HARQ processes 1, . . . , N for communication with TPRs 1 . . . , m. N is an integer and larger than zero, and m is an integer and larger than zero. For example, N is 8, 16, 32, etc., and m is 2, 3 4, etc.

Next, FIG. 4B depicts further implementations of a HARQ entity 400B, similar to the HARQ entity 400A. The difference between the implementations of HARQ entities 400B and 400A is that the HARQ entity 400B partitions the HARQ processes 1, . . . , N into m groups, where each is used for communication with a particular TRP.

Next, FIG. 4C depicts an implementation of a HARQ entity 400C (e.g., HARQ entity k), similar to the HARQ entity 400A. The difference between the implementations of HARQ entities 400C and 400A is that the HARQ entity 400C is used for communication with a particular TRP (e.g., TRPk) on a particular CC (e.g., CCk), where 1<=k<=m. In other words, the UE 102 uses HARQ entity 1, . . . , m to communicate with a RAN node (e.g., the base station 104 or 106, or DU 174) via TRPs 1, . . . , m on each UL CC, respectively. Similarly, the RAN node uses HARQ entity 1, . . . , m to communicate with the UE 102 via TRPs 1, . . . , m of the RAN node (e.g., the base station 104 or 106, or DU 174) on each DL CC, respectively.

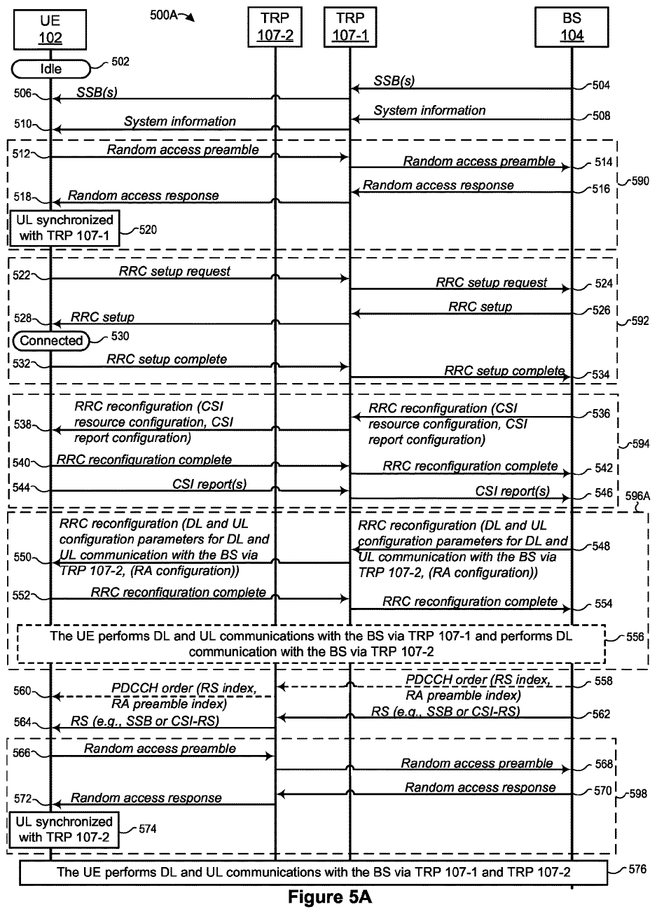

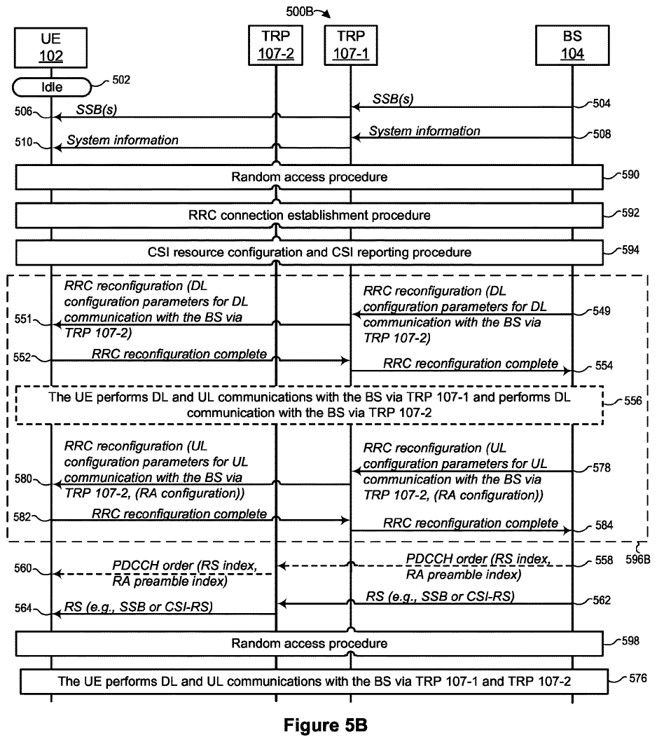

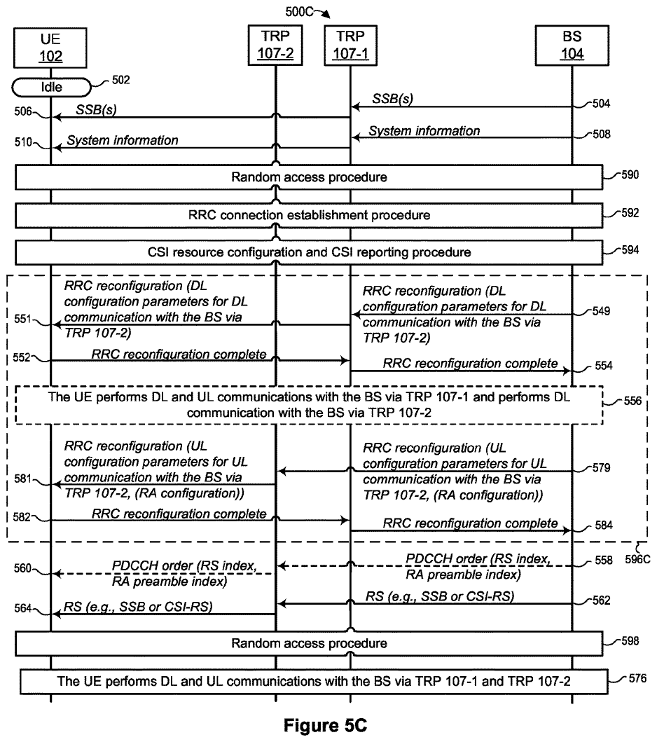

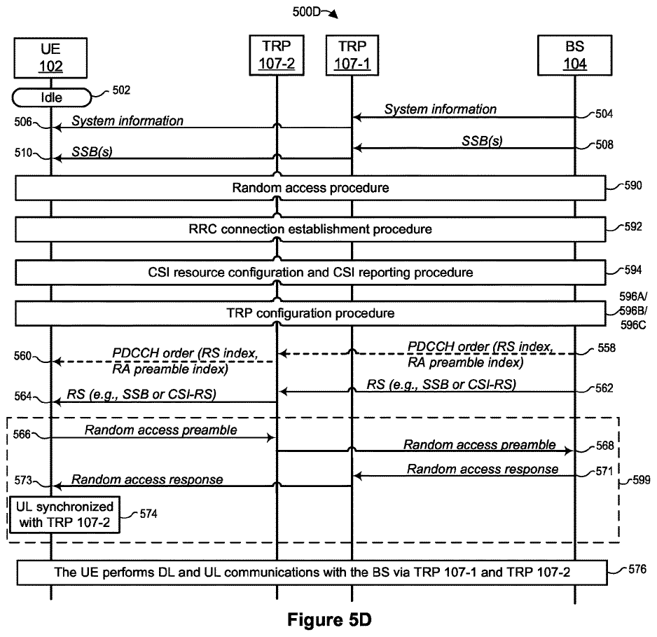

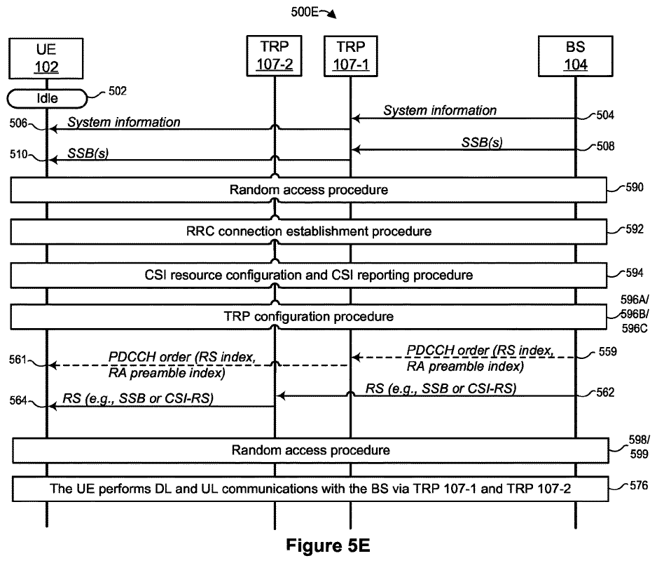

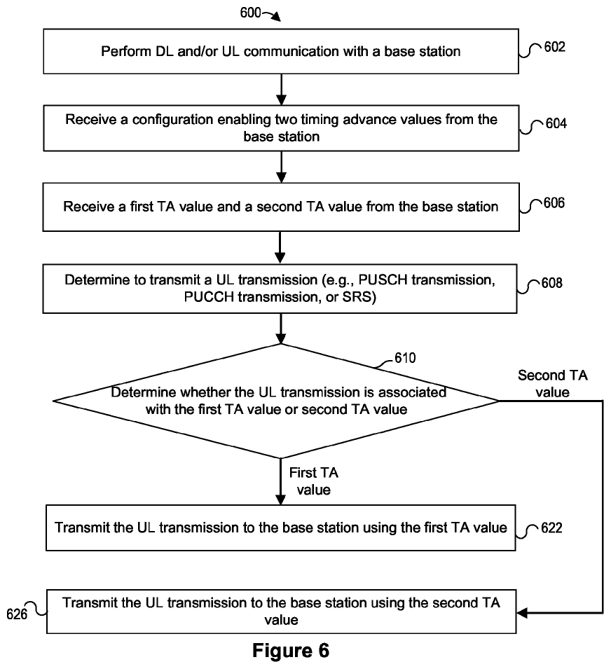

Next, several example scenarios that involve various components of FIG. 1A and relate to mTRP operation are discussed with reference to FIGS. 5A-5E. Generally, events in FIGS. 5A-5E that can be the same are labeled with the same reference numbers.

Referring first to FIG. 5A, in a scenario 500A, a base station 104 operates the cell 124, the TRP 107-1, and TRP 107-2. In the scenario 500A, the base station 104 broadcasts (e.g., periodically) 504, 506 one or more synchronization signal blocks (SSB(s)) and 508, 510 system information via the TRP 107-1. In some implementations, the system information includes master information block(s) (MIB) and/or system information block(s) (SIB(s)). In some examples, the SIB(s) include an SIB1 and further include an SIB2, SIB3, SIB4, and/or SIB5. The UE 102 initially operates 502 in an idle state (e.g., RRC_IDLE state). The UE 102 in the idle state receives 504, 506 the SSB(s) and 508, 510 the system information from the base station 104 via the TRP 107-1. In some implementations, the UE 102 detects that the base station 104 transmits the SSB(s) via the TRP 107-1. In some implementations, the UE 102 then uses one of the SSB(s) to perform downlink synchronization on the cell 124 with the base station 104 via the TRP 107-1, and receives 508, 510 the system information via the TRP 107-1 based on the SSB.

Later in time, the UE 102 determines to perform 590 a random access procedure to perform 592 an RRC connection establishment procedure. In response to the determination, the UE 102 transmits 512 a first random access preamble on a time/frequency resource and/or a random access channel (RACH) occasion to the TRP 107-1. The TRP 107-1 then forwards 514 the first random access preamble to the base station 104. In some implementations, the UE 102 selects an SSB from the SSB(s), for which an RSRP obtained by the UE 102 is above a first threshold (e.g., rsrp-ThresholdSSB), for the random access procedure. In other implementations, in cases where an RSRP for any SSB in the SSB(s) is not above the first threshold, the UE 102 selects an SSB from the SSB(s) and uses the SSB to determine the first random access preamble. In some such cases, the UE 102 selects the SSB from the SSB(s) randomly, or selects based on a UE-implementation. The UE 102 then determines the first random access preamble, time/frequency resource, and/or RACH occasion based on the selected SSB and random access configuration parameters included in the system information (e.g., the SIB1). In some implementations, the random access configuration parameters indicate one or more associations between (i) SSB(s) and (ii) random access preamble(s), RACH occasion(s), and/or time/frequency resource(s). Based on the selected SSB and the association(s), the UE 102 determines the first random access preamble, the RACH occasion, and/or time/frequency resource(s) to transmit the first random access preamble.

In response to the first random access preamble, the base station 104 transmits 516 a first random access response to the TRP 107-1. The TRP 107-1 then forwards 518 the first random access response to the UE 102. In some implementations, the base station 104 or TRP 107-1 identifies an SSB associated with the first random access preamble, RACH occasion, and/or time/frequency resource. In some cases where a single SSB is associated with the first random access preamble, RACH occasion, and/or time/frequency resource, the identified SSB is the SSB selected by the UE 102. In some cases where multiple SSBs are associated with the first random access preamble, RACH occasion, and/or time/frequency resource, the identified SSB is the same as or different from the SSB selected by the UE 102. In such implementations, the base station 104 transmits the first random access response to the UE 102 via the TRP 107-1, based on the identified SSB. The base station 104 includes a first preamble ID and a first TA command in the first random access response. The first preamble ID identifies the first random access preamble, and the first TA command includes a first TA value. The UE applies the first TA value and determines or maintains 520 an uplink that is synchronized (e.g., time aligned) with the TRP 107-1 after (e.g., in response to) applying the first TA value. The UE 102 applies the first TA value for transmitting UL transmissions (e.g., PUCCH transmissions, PUSCH transmissions, and/or sounding reference signal transmissions) until a new or different TA value is received from base station 104 that updates the first TA value. In some implementations, the UE 102 starts a first time alignment timer (TAT) to maintain a UL synchronization status with the TRP 107-1 or base station 104 after or upon receiving the first TA command. In some implementations, the base station 104 includes a UL grant (i.e., a RAR grant) in the random access response.

In some implementations, the base station 104 starts a first TAT to maintain a first UL synchronization for UL and/or DL communication with the UE 102 via the TRP 107-1 after transmitting the random access response or the first TA command to the UE 102. In some implementations, the TRP 107-1 generates timing information for or based on the first random access preamble received from the UE 102 and transmits the timing information to the base station 104. In some examples, the timing information indicates a propagation delay or a propagation delay shift. Based on the timing information received from the TRP 107-1, the base station 104 determines the first TA value.

The blocks 512, 514, 516, 518, and 520 are collectively referred to in FIG. 5A as a random access procedure 590.

During or after the random access procedure 590, the UE 102 transmits 522, 524 an RRC setup request message (e.g., RRCSetupRequest message) to the base station via the TRP 107-1. In some implementations, the UE 102 transmits the RRC setup request message using the UL grant received in the random access response. In response to the RRC setup request message, the base station 104 transmits 526, 528 an RRC setup message (e.g., RRCSetup message) to the UE 102 via the TRP 107-1. In some implementations, the base station 104 transmits a MAC PDU including contention resolution (e.g., MAC control element (CE)) to the UE 102 to resolve a contention for the random access procedure. In some implementations, the base station 104 includes the RRC setup message in the MAC PDU. In further implementations, after transmitting the MAC PDU, the base station 104 transmits another MAC PDU, including the RRC setup message, to the UE 102. In response to the RRC setup message, the UE 102 transitions 530 to a connected state (e.g., RRC_CONNECTED) and transmits 532, 534 an RRC setup complete message (e.g., RRCSetupComplete message) to the base station 104 via the TRP 107-1. In some implementations, after performing the RRC connection establishment procedure with the UE 102, the base station 104 performs a security activation procedure with the UE 102 to activate security protection (e.g., integrity protection/integrity check and encryption/decryption) for UL data and DL data communicated between the UE 102 and base station 104. In further implementations, after performing the RRC connection establishment procedure or security activation procedure, the base station 104 performs a radio bearer configuration procedure with the UE 102 to configure an SRB2 and/or a DRB for the UE 102.

After performing the RRC connection establishment procedure, security activation procedure or radio bearer configuration procedure, the base station 104 transmits 536, 538, to the UE 102 via the TRP 107-1, an RRC reconfiguration message (e.g., RRCReconfiguration message) including a channel state information (CSI) resource configuration and a CSI reporting configuration. In response, the UE 102 transmits 540, 542 an RRC reconfiguration complete message (e.g., RRCReconfigurationComplete message) to the base station 104 via the TRP 107-1. In some implementations, the CSI resource configuration includes configuration parameters configuring channel state information reference signal(s) (CSI-RS(s)) for the UE 102 to measure. The base station 104 transmits the CSI-RS(s) via the TRP 107-2 in accordance with the CSI resource configuration. The UE 102 performs measurements on the CSI-RS(s) in accordance with the CSI resource configuration. In some implementations, the CSI resource configuration includes configuration parameters configuring SSB(s) for the UE 102 to measure. The base station 104 transmits the SSB(s) via the TRP 107-2. The UE 102 performs measurements on the SSB(s) in accordance with the CSI resource configuration. In other implementations, the RRC reconfiguration message or CSI resource configuration does not include configuration parameters configuring SSB(s). In some such cases, the base station 104 still transmits SSB(s) via the TRP 107-2, and the UE 102 performs measurements on the SSB(s). Based on the CSI reporting configuration, the UE 102 generates CSI report(s) from the measurements of the CSI-RS(s) or the SSB(s) and transmits 544, 546 the CSI report(s) to the base station 104 via the TRP 107-1. In some implementations, the UE 102 transmits the CSI report(s) on a PUCCH to the base station 104 via the TRP 107-1. In some implementations, the CSI reporting configuration configures a periodic or semi-persistent reporting, or the CSI reporting configuration configures a semi-persistent or aperiodic reporting triggered by a DCI. The CSI report(s) include periodic CSI report(s), semi-persistent CSI report(s), and/or aperiodic CSI report(s).

In some implementations, the base station 104 includes the CSI resource configuration and/or the CSI report configuration in a CSI measurement configuration (e.g., CSI-MeasConfig IE). The base station 104 then includes the CSI measurement configuration in the RRC reconfiguration message of events 536, 538. In other implementations, the CSI resource configuration includes NZP-CSI-RS-Resource IE(s), NZP-CSI-RS-ResourceSet IE(s), CSI-SSB-ResourceSet IE(s), CSI-ResourceConfig IE(s), and/or CSI-ReportConfig IE(s).

The blocks 536, 538, 540, 542, 544, and 546 are collectively referred to in FIG. 5A as a CSI resource configuration and CSI reporting procedure 594.

After receiving the CSI report(s) at event 546, the base station 104 determines to communicate with the UE 102 via the TRP 107-2 based on the CSI report(s) while maintaining the link with the UE 102 via the TRP 107-1. In some implementations, the base station 104 makes the determination based on one or more capabilities of the UE 102. In response to the determination, the base station 104 transmits 548, 550, to the UE 102 via the TRP 107-1, an RRC reconfiguration message that includes DL and UL configuration parameters for DL and UL communication with the base station 104 via TRP 107-2, respectively. In some implementations, the base station 104 includes the DL and UL configuration parameters in a CellGroupConfig IE and includes the CellGroupConfig IE in the RRC reconfiguration message. In some implementations, the base station 104 includes the DL configuration parameters in a bandwidth part (BW) IE, such as a BWP-DownlinkDedicated IE, and includes the BWP-DownlinkDedicated IE in the RRC reconfiguration message. In some implementations, the base station 104 includes the UL configuration parameters in a BWP-UplinkDedicated IE and includes the BWP-UplinkDedicated IE in the RRC reconfiguration message.

In response to the RRC reconfiguration complete message, the UE 102 transmits 552, 554 an RRC reconfiguration complete message to the base station 104 via the TRP 107-1. In some implementations, the UE 102 applies the DL configuration parameters upon receiving the RRC reconfiguration message at event 554. In such implementations, the UE 102 performs 556 DL communication with the base station 104 via the TRP 107-2 in accordance with the DL configuration parameters, while performing DL and UL communications with the base station 104 via TRP 107-1. In some implementations, the UE 102 refrains from performing UL communication in accordance with the UL configuration parameters until after performing the random access procedure with the base station 104 via the TRP 107-2 at event 598. In further implementations, the UE 102 refrains from performing DL communication with the base station 104 via the TRP 107-2 until after performing the random access procedure with the base station 104 via the TRP 107-2 at event 598. In some implementations, the base station 104 refrains from performing UL communication and/or configuring the UL configuration parameters until after the random access procedure with the base station 104 via the TRP 107-2 at event 598 is completed. In some implementations, the base station 104 refrains from performing DL communication and/or configuring the DL configuration parameters until after the random access procedure with the base station 104 via the TRP 107-2 at event 598 is completed.

In some implementations, the base station 104 and UE 102 use a HARQ entity in FIGS. 4A, 4B, or 4C to perform DL communication with the base station 104 via the TRP 107-1 and TRP 107-2 at event 556. In some cases, such as with the HARQ entity 400B of FIG. 4B, the DL configuration parameters of events 548, 550 include HARQ configuration parameters. The HARQ configuration parameters configure a first set of HARQ process IDs and a second set of HARQ process IDs. In some cases, the first set of HARQ process IDs and the second set of HARQ process IDs are for the TRP 107-1 and the TRP 107-2, respectively. The first set of HARQ process IDs and second set of HARQ process IDs identify a first set of HARQ processes of the HARQ entity and a second set of HARQ processes of the HARQ entity, respectively. In some implementations, none of the first set of HARQ process IDs and second set of HARQ process IDs are identical. In other implementations, some of the first set of HARQ process IDs and second set of HARQ process IDs are identical and the others are different.

In some implementations, the base station 104 transmits, to the UE 102, one or more MAC control elements (CEs) or DCIs to change or update one or more HARQ process IDs in the first set of HARQ process IDs. In some implementations, the base station 104 transmits, to the UE 102, one or more MAC CEs or DCIs to change or update one or more HARQ process IDs in the second set of HARQ process IDs. In some alternative implementations, the base station 104 does not configure the first set of HARQ process IDs and second set of HARQ process IDs in the DL configuration parameters. In some implementations, the base station 104 determines the first set of HARQ process IDs and second set of HARQ process IDs for mTRP operation based on a pre-configuration. In further implementations, the first set of HARQ process IDs and second set of HARQ process IDs are specific, pre-determined IDs (e.g., as specified in a 3GPP specification). In yet further implementations, the base station 104 determines the first set of HARQ process IDs and second set of HARQ process IDs based on a rule.

In some implementations, when the base station 104 determines to schedule the UE 102 to receive a DL transmission to the TRP 107-1, the base station 104 selects a HARQ process ID from the first set of HARQ process IDs and transmits a DCI, including a DL assignment, and the selected HARQ process ID to the UE 102. The UE 102 uses a HARQ process identified by the selected HARQ process ID and receives a DL transmission from the base station 104 using the HARQ process and UL grant. Similarly, when the base station 104 determines to schedule the UE 102 to transmit a UL transmission to the TRP 107-2, the base station 104 selects a HARQ process ID from the second set of HARQ process IDs and transmits a DCI, including a UL grant, and the selected HARQ process ID to the UE 102. The UE 102 uses a HARQ process identified by the selected HARQ process ID and receives a DL transmission from the base station 104 using the HARQ process and DL assignment.

In some implementations, the one or more capabilities include at least one first capability indicating that the UE 102 supports mTRP operation (e.g., release 16 capability field(s)/IE(s) and/or release 17 capability field(s)/IE(s) in 3GPP specification 38.306 or 38.331 v17.1.0 or later versions for mTRP operation). In some implementations, the base station 104 determines to configure the DL configuration parameters for DL communication with the base station 104 via the TRP 107-2 based on the at least one first capability. In some implementations, the base station 104 determines the UL configuration parameters for UL communication with the base station 104 via the TRP 107-2 based on the at least one first capability. In cases where the base station 104 includes a DU 174 and a CU 172, the DU 174 makes the determination(s).

In some implementations, the one or more capabilities include at least one second capability. In some such implementations, the at least one second capability indicates that the UE 102 supports multiple UL transmission timings (i.e., operation of two or more TAs) for mTRP operation with a serving cell. In further implementations, the at least one second capability indicates that the UE 102 supports multiple UL transmission timings (for mTRP operation) with a serving cell and a non-serving cell. A Physical Cell Index (PCI) of the non-serving cell is different from a PCI of the serving cell. In some implementations, the least one second capability includes the number of UL transmission timings that the UE 102 support (for mTRP operation) with a serving cell and/or across all serving cell(s) configured/activated for the UE 102. In further implementations, the at least one second capability does not include the number of UL transmission timings (for mTRP operation) and indicates that the UE 102 supports a default number (e.g., 2) of UL transmission timings. In some implementations, the base station 104 determines to configure the UL configuration parameters for UL communication with the base station 104 via the TRP 107-2 based on the at least one second capability. In cases where the base station 104 includes a DU 174 and a CU 172, the DU 174 makes the determination.

In some implementations, the base station 104 receives the one or more capabilities from the UE 102, after receiving the RRC setup complete message or performing the security activation procedure with the UE 102. In some implementations, the base station 104 transmits a UE capability enquiry message (e.g., UECapabilityEnquiry message) to the UE 102 and receives a UE capability information message (e.g., UECapabilityInformation message) including the one or more capabilities from the UE in response.

In other implementations, the base station 104 receives a CN-to-BS message including the one or more capabilities from the CN 110 (e.g., after receiving the RRC setup complete message). In some implementations, the base station 104 transmits a BS-to-CN message to the CN 110 after receiving the RRC setup complete message and the CN 110 transmits the CN-to-BS message after (e.g., in response to) receiving the BS-to-CN message. In some implementations, the UE 102 transmits a NAS message (e.g., Registration Request message or Registration Complete message), including a capability ID identifying the one or more capabilities, to the CN 110, and the CN 110 obtains the one or more capabilities from the capability ID. In other implementations, the UE 102 performs a registration procedure with the CN 110 via a base station (e.g., the base station 104 or 106) before event 502 to register to the CN 110. During the registration procedure, the UE 102 receives a UE capability enquiry message (e.g., UECapabilityEnquiry message) from the base station and transmits a UE capability information message (e.g., UECapabilityInformation message), including the one or more capabilities, to the base station. The base station transmits a BS-to-CN message, including the one or capabilities, to the CN 110, and the CN 110 stores the one or more capabilities. In some implementations, the CN-to-BS message and BS-to-CN messages are NG application protocol (NGAP) messages. In cases where the base station 104 includes a DU 174 and a CU 172, the CU 172 transmits a CU-to-DU message including the one or more capabilities to the DU 174. In some implementations, the CU-to-DU message is an F1 application protocol (F1AP) message.

In some implementations, the base station 104 can include, in the RRC reconfiguration message, random access configuration parameters for the UE 102 to perform 598 the random access procedure. In some implementations, the random access configuration parameters are dedicated to the UE 102. For example, the base station 104 generates a RACH configuration (e.g., RACH-ConfigDedicated, RACH-ConfigDedicated-r18, or RACH-ConfigDedicated-v1800 IE) including the random access configuration parameters dedicated to the UE 102. In some implementations, the format of an RRCReconfiguration message includes Reconfiguration WithSync IE and the ReconfigurationWithSync IE includes a RACH-ConfigDedicated IE (e.g., a RACH configuration or including random access configuration parameters) (e.g., as specified in 3GPP specification 38.331 v 17.0.0 or later versions). In cases where the RRC reconfiguration message is an RRCReconfiguration message, the base station 104 includes, in the RRCReconfiguration message, the RACH configuration or the random access configuration parameters for the RRCReconfiguration message, without including a Reconfiguration WithSync IE and wrapping the RACH configuration or the random access configuration parameters in the Reconfiguration WithSync IE. If the base station 104 uses the Reconfiguration WithSync IE to include the random access configuration parameters, the Reconfiguration WithSync IE causes the UE 102 to perform a handover, which causes an interruption in the communication between the UE 102 and the base station 104. In other implementations, the base station 104 refrains from including random access configuration parameters in the RRC reconfiguration message.

In some implementations, the base station 104 indicates that UL synchronization is required in the RRC reconfiguration message (i.e., for communication with the base station 104 over the second TRP). That is, the base station 104 configures the UE 102 to obtain (second) UL synchronization for communication between the UE 102 and TRP 107-1 while maintaining the first UL synchronization for communication between the UE 102 and TRP 107-2. In other words, the base station 104 configures the UE to maintain two TA values for communications between the UE 102 and base station 104 (e.g., between the UE 102 and TRP 107-1 and between the UE 102 and TRP 107-2, respectively). In further implementations, the base station 104 includes, in the RRC reconfiguration message, a configuration (e.g., a field or IE (e.g., RRC Release 18 field or IE)), indicating that UL synchronization is required for communication between the UE 102 and TRP 107-2. In other words, the configuration enables operation of two TA values for communications between the UE 102 and base station 104 (e.g., between the UE 102 and TRP 107-1 and between the UE 102 and TRP 107-2, respectively).

In some implementations, the UE 102 initiates the random access procedure 598 in response to receiving the the field or IE, before transmitting UL transmissions (e.g., channel state information (CSI) report, a sounding reference signal (SRS), PUCCH transmissions, and/or PUSCH transmissions) to the base station over the TRP 107-2. In some such implementations, i the RRC reconfiguration message does not include the field or IE, the UE 102 does not initiate a random access procedure and transmits UL transmissions to the base station over the TRP 107-2. In further implementations, the UE 102 refrains from transmitting UL transmissions to the base station over the TRP 107-2 in response to receiving the field or IE. In some such cases, the UE 102 does not transmit a random access preamble to the base station 104 via the TRP 107-2 until receiving a PDCCH order from the base station (e.g., events 558, 560, 559, 561).

The blocks 548, 550, 552, 554, and 556 are collectively referred to in FIG. 5A as a TRP configuration procedure 596A.

In some implementations, after receiving the RRC reconfiguration message at event 538, after performing the CSI resource configuration and CSI reporting procedure 594, or after performing the TRP configuration procedure 596A with the base station 104, the UE 102 receives 562, 564 an RS from the base station 104 via the TRP 107-2. Depending on the implementation, the RS is configured in the CSI resource configuration of event 538, and the events 562, 564 occur after receiving the RRC reconfiguration message at event 538, during or after the CSI resource configuration and CSI reporting procedure 594, or during or after the TRP configuration procedure 596A. After performing the TRP configuration procedure 596A with the base station 104, the UE 102 initiates 598 a random access procedure. In response to initiating the random access procedure, the UE 102 transmits 566, 568 a second random access preamble on a time/frequency resource and a random access channel (RACH) occasion to the base station 104 via the TRP 107-2. In response to the second random access preamble, the base station 104 transmits 570, 572 a second random access response to the UE 102 via the TRP 107-2. The base station 104 includes a second preamble ID and a second TA command in the second random access response. The second preamble ID identifies the second random access preamble, and the second TA command includes a second TA value. The UE applies the second TA value and determines or maintains 574 an uplink synchronized with the TRP 107-2 after (e.g., in response to) applying the second TA value. The UE 102 applies the second TA value to transmit UL transmissions (e.g., PUCCH transmissions, PUSCH transmissions, and/or SRS transmissions) until the UE 102 receives a new or different TA value from base station 104 that updates the second TA value. In some implementations, the UE 102 starts a second TAT to maintain or manage UL synchronization status with the TRP 107-2 or base station 104 after or upon receiving the second TA command. In some implementations, the base station 104 includes a UL grant (e.g., a RAR grant) in the second random access response, and the UE 102 transmits a UL MAC PDU to the base station 104 via the TRP 107-2 in accordance with the UL grant. In cases where the random access procedure is a contention-based random access procedure, the UE 102 includes a C-RNTI of the UE 102 in the UL MAC PDU. The base station 104 identifies the UE 102 based on the C-RNTI. In response to the identification, the base station 104 generates a DCI and a CRC for the DCI, scrambles the CRC with the C-RNTI, and transmits the DCI and scrambled CRC on a PDCCH to the UE 102. In some implementations, the DCI includes n UL grant. Upon receiving the DCI and scrambled CRC on the PDCCH, the UE 102 determines that the content-based random access procedure 598 is performed successfully. In cases where the random access procedure 598 is a contention-free random access procedure, the UE 102 determines that the content-based random access procedure 598 is performed successfully in response to receiving the second random access response message.

In some implementations, the base station 104 starts a second TAT to maintain a second UL synchronization for UL and/or DL communication with the UE 102 via the TRP 107-2 after (e. g .., in response to) transmitting the second TA command to the UE 102. In some implementations, the TRP 107-1 generates timing information for the second random access preamble received from the UE 102 and transmits the timing information to the base station 104. As an example, the timing information indicates a propagation delay or a propagation delay shift. Based on the timing information received from the TRP 107-2, the base station 104 determines the second TA value.

The blocks 566, 568, 570, 572, and 574 are collectively referred to in FIG. 5A as a random access procedure 598.

In some implementations, the UE 102 suspends communication (e.g., reception of DL channel/RS or transmission of UL channel/RS) with the base station 104 via the TRP 107-1 while performing the random access procedure 598. Depending on the implementation, the UE 102 does so if the UE 102 is not capable of simultaneously performing a random access procedure based on a UL beam or a RS (i.e., toward a TRP) and communicating UL and DL transmissions (i.e., not related to the random access procedure) based on another UL beam or RS (i.e., toward another TRP). In other implementations, the UE 102 continues communication with the base station 104 via the TRP 107-2 while performing the random access procedure 598. After successfully completing 598 the random access procedure, the UE performs 576 DL and UL communications with the BS via TRP 107-1 and TRP 107-2 in accordance with the first TA value and second TA value, respectively.

In some implementations, the base station 104 and UE 102 use a HARQ entity (e.g., as depicted in FIGS. 4A, 4B, or 4C) to perform UL communication with the base station 104 via the TRP 107-1 and TRP 107-2 at event 576. In some cases (e.g., with the exemplary HARQ entity of FIG. 4B), the UL configuration parameters of events 548, 550 include HARQ configuration parameters. The HARQ configuration parameters configure a first set of HARQ process IDs and a second set of HARQ process IDs. In some cases, the first set of HARQ process IDs and the second set of HARQ process IDs are for the TRP 107-1 and TRP 107-2, respectively. The first set of HARQ process IDs and second set of HARQ process IDs identify a first set of HARQ processes of the HARQ entity and a second set of HARQ processes of the HARQ entity, respectively. In some implementations, none of the first set of HARQ process IDs and second set of HARQ process IDs are identical. In other implementations, some of the first set of HARQ process IDs and second set of HARQ process IDs are identical and others are different.

In some implementations, the base station 104 transmits, to the UE 102, one or more MAC CEs or DCIs to change or update one or more HARQ process IDs in the first set of HARQ process IDs. In some further implementations, the base station 104 transmits, to the UE 102, one or more MAC CEs or DCIs to change or update one or more HARQ process IDs in the second set of HARQ process IDs. In some alternative implementations, the base station 104 does not configure the first set of HARQ process IDs and second set of HARQ process IDs in the UL configuration parameters. In some implementations, the base station 104 determines the first set of HARQ process IDs and second set of HARQ process IDs for mTRP operation based on a pre-configuration. In further implementations, the first set of HARQ process IDs and second set of HARQ process IDs are specified sets (e.g., as specified in a 3GPP specification). In yet further implementations, the base station 104 determines the first set of HARQ process IDs and second set of HARQ process IDs based on a rule.

In some implementations, when the base station 104 determines to schedule the UE 102 to transmit a UL transmission to the TRP 107-1, the base station 104 selects a HARQ process ID from the first set of HARQ process IDs and transmits a DCI, including a UL grant, and the selected HARQ process ID to the UE 102. The UE 102 uses a HARQ process identified by the selected HARQ process ID and transmits a UL transmission to the base station 104 using the HARQ process and UL grant. Similarly, when the base station 104 determines to schedule the UE 102 to transmit a UL transmission to the TRP 107-2, the base station 104 selects a HARQ process ID from the second set of HARQ process IDs and transmits a DCI, including a UL grant, and the selected HARQ process ID to the UE 102. The UE 102 uses a HARQ process identified by the selected HARQ process ID and transmits a UL transmission to the base station 104 using the HARQ process and UL grant.

In some implementations, after receiving the RRC reconfiguration complete message at event 554, the base station 104 transmits 558, 560 a PDCCH order to the UE 102 via the TRP 107-2 to cause the UE 102 to initiate the random access procedure 598 with the base station 104 via the TRP 107-2. In some implementations, the PDCCH order includes an RS index and a random access preamble index. Alternatively, the base station 104 transmits the PDCCH order to the UE 102 via the TRP 107-1. In response to the PDCCH order, the UE 102 transmits the random access preamble to the base station 104 via the TRP 107-2 at event 566. In some implementations, the random access preamble index includes a value of the second preamble ID identifying the second random access preamble. Thus, the UE 102 determines the second random access preamble in accordance with the random access preamble index. In other implementations, the random access preamble index includes a value indicating or instructing the UE 102 to determine a random access preamble. Thus, the UE 102 determines the second random access preamble by (randomly) selecting it from the random access preambles configured in the system information.

In some implementations, the PDCCH order is a DCI. The base station 104 generates the DCI and a CRC for the DCI, scrambles the CRC with the C-RNTI, and transmits the DCI and scrambled CRC to the TRP 107-2 (e.g., via a fiber connection). In turn, the TRP 107-2 transmits the DCI and scrambled CRC on a PDCCH to the UE 102. In some implementations, the base station 104 transmits a first packet including the DCI and scrambled CRC to the TRP 107-2. In some implementations, the base station 104 transmits, to the TRP 107-2, control information configuring or indicating time and/or frequency resources for the PDCCH. In some implementations, the time and/or frequency resources include subcarriers, resource elements, or physical resource block(s). The TRP 107-2 transmits the DCI and scrambled CRC on the time and/or frequency resource in accordance with the control information. In some implementations, the base station 104 includes the control information in the first packet. In other implementations, the base station 104 transmits, to the TRP 107-2, a second packet including the control information, instead of the first packet. In other implementations, the base station 104 does not transmit control information for the DCI and scrambled CRC to the TRP 107-2. In such implementations, the TRP 107-2 determines time and/or frequency resources for the PDCCH and transmits the DCI and scrambled CRC on the time and/or frequency resources.

In some implementations, the RS index (e.g., SSB index) identifies one of the SSB(s). In some such implementations, the base station 104 determines or decodes the SSB index indicated in the CSI report(s). In further implementations, the base station 104 determines or decodes the SSB index based on a radio resource (e.g., PUCCH resource) where the base station 104 receives one of the CSI report(s) for the SSB. In some such implementations, the base station 104 configures a different radio resource for the UE 102 to transmit a CSI report for each of the SSB(s). In some examples, the base station 104 includes, in the RRC reconfiguration message of event 536, a configuration configuring a different radio resource (e.g., PUCCH resource) for the UE 102 to transmit a CSI report for each of the SSB(s). In some implementations, the UE 102 determines a time/frequency resource and/or a RACH occasion, based on the SSB (e.g., indicated in the RS index) and the random access configuration parameters received in the system information, and transmits the second random access preamble on the time/frequency resource and/or RACH occasion. In other implementations, the UE 102 determines a time/frequency resource and/or a RACH occasion, based on the SSB (e.g., indicated in the RS index) and the random access configuration parameters received in the RRC reconfiguration message of event 550, and transmits the second random access preamble on the time/frequency resource and/or RACH occasion.

In other implementations, the RS index (e.g., CSI-RS index) identifies one of the CSI-RS(s). In some implementations, the base station 104 determines or decodes the CSI-RS index indicated in the CSI report(s). In further implementations, the base station 104 determines or decodes the CSI-RS index based on a radio resource (e.g., PUCCH resource) where the base station 104 receives the CSI report(s) for the CSI-RS. In some such implementations, the base station 104 configures a different radio resource for the UE 102 to transmit a CSI report for each of the CSI-RS(s). In some examples, the base station 104 includes, in the RRC reconfiguration message of event 536, a configuration configuring a different radio resource (e.g., PUCCH resource) for the UE 102 to transmit a CSI report for each of the CSI-RS(s). In some implementations, the UE 102 determines a time/frequency resource and/or a RACH occasion, based on the CSI-RS (e.g., indicated in the RS index) and the random access configuration parameters in the RRC reconfiguration message that the UE 102 receives at event 550. The UE 102 transmits the second random access preamble on the time/frequency resource and/or RACH occasion. In some implementations, the random access configuration parameters indicate one or more associations between CSI-RS(s), and RACH occasion(s) and/or time/frequency resource(s).

In some implementations, the UE 102 determines transmission characteristics (e.g., spatial transmission filters/parameters) based on or by referring to the RS index in the PDCCH order and transmits the second random access preamble to the TRP 107-2 using the determined transmission characteristics. In some examples, the UE 102 uses reception characteristics for receiving 564 the RS identified by the RS index to derive the transmission characteristics. In some implementations, the transmission characteristics include phase, power, and/or transmission precoder. In some implementations, the UE 102 further uses the DL and/or UL configuration parameters of event 550 to determine the transmission characteristics. In further implementations, the UE 102 uses configuration parameters in the system information of event 510 to determine the transmission characteristics. In some implementations, the UE 102 determines transmission characteristics (e.g., spatial transmission filters/parameters) not based on or not referring to the RS index in the PDCCH order and transmits the second random access preamble to the TRP 107-2 using the determined transmission characteristics.

In some implementations, the UE 102 initiates 598 the random access procedure, in response to the random access configuration parameters received at event 550 and after receiving the RS at event 564. In such implementations, the base station 104 does not transmit the PDCCH order to cause the UE 102 to perform the random access procedure 598.

In some implementations, the RRC reconfiguration message of event 550 includes configuration parameters (e.g., for a PDCCH configuration, search space configuration, and/or control resource set (CORESET) configuration) for the UE 102 to receive DL transmissions from the TRP 107-2. In some implementations, the UE 102 receives the second random access response in accordance with the configuration parameters. In other implementations, the system information of event 510 includes configuration parameters for the UE 102 to receive a random access response from the TRP 107-2. In such implementations, the UE 102 receives the second random access response in accordance with the configuration parameters. In some implementations, the UE 102 uses reception characteristics for receiving 564 the RS to receive the second random access response from the TRP 107-2.

Although the TRP 107-2 is used in the scenario 500A, the above description can be applied to a scenario where the TRP 107-3 is used instead of the TRP 107-2. In such a scenario, after successfully completing a random access procedure with the base station via the TRP 107-3 and cell 125, similar to the procedure 598, the UE performs DL and UL communications with the base station via TRP 107-1 and TRP 107-3 in accordance with the first TA value and second TA value, respectively.

In some scenarios or implementations, the base station 104 transmits, to the UE 102 via the TRP 107-1 or TRP 107-2, a third TA command including a first new TA value to update the first TA value. In some implementations, the third TA command is a MAC control element (CE). The UE 102 applies the first new TA value for the first UL synchronization and restarts the first TAT of the UE 102 in response to receiving the third TA command. The base station 104 restarts the first TAT of the base station 104 in response to transmitting the third TA command. In some scenarios or implementations, the base station 104 transmits, to the UE 102 via the TRP 107-1 or TRP 107-2, a fourth TA command including a second new TA value to update the second TA value. In some implementations, the fourth TA command is a MAC CE. The UE 102 applies the second new TA value for the second UL synchronization and restarts the second TAT in response to receiving the fourth TA command. In some scenarios or implementations, the base station 104 transmits, to the UE 102 via the TRP 107-1 or TRP 107-2, a single TA command including the first new TA value and the second new TA value to update the first TA value and second TA value, respectively. In some implementations, the single TA command is a new or existing MAC control element (CE) (e.g., as defined in 3GPP specification 38.321V 17.1.0 ).

In some implementations, the TRP 107-1 generates timing information based on UL transmission(s) received from the UE 102 and transmits the timing information to the base station 104. In some examples, the timing information indicates a propagation delay or a propagation delay shift. Based on the timing information received from the TRP 107-1, the base station 104 determines whether to update the first TA value. In some implementations, if the propagation delay or the propagation delay shift is larger than or equal to a first threshold, the base station 104 determines to update the first TA value. Otherwise, if the propagation delay or the propagation delay shift is smaller than a second threshold, the base station 104 determines not to update the first TA value. In some implementations, if the base station 104 determines to update the first TA value, the base station 104 generates the first new TA value. In some implementations, the TRP 107-2 generates timing information based on UL transmission(s) received from the UE 102 and transmits the timing information to the base station 104. In some examples, the timing information indicates a propagation delay or a propagation delay shift. Based on the timing information received from the TRP 107-2, the base station 104 determines whether to update the second TA value. In some implementations, if the propagation delay or the propagation delay shift is larger than or equal to a third threshold, the base station 104 determines to update the second TA value. Otherwise, if the propagation delay or the propagation delay shift is smaller than a fourth threshold, the base station 104 determines not to update the first TA value. In some implementations, if the base station 104 determines to update the second TA value, the base station 104 generates the second new TA value. Depending on the implementation, the first, second, third, and fourth thresholds are the same or different.

Turning to FIG. 5B, a scenario 500B is similar to the scenario 500A, with differences described below. In the scenario 500B, the base station 104 transmits 549, 551, to the UE 102 via the TRP 107-1, an RRC reconfiguration message that includes the DL configuration parameters for DL communication with the base station 104 via the TRP 107-2. In some implementations, the base station 104 includes, in the RRC reconfiguration message, UL configuration parameters for UL communication with the base station 104 via the TRP 107-1 (e.g., to configure or enable DL communication with the base station 104 via the TRP 107-2). In some implementations, the base station 104 includes the DL configuration parameters in a CellGroupConfig IE and includes the CellGroupConfig IE in the RRC reconfiguration message. In some implementations, the base station 104 includes the DL configuration parameters in a BWP-DownlinkDedicated IE and includes the BWP-DownlinkDedicated IE in the RRC reconfiguration message. The RRC reconfiguration message of events 549, 551 is similar to the RRC reconfiguration message of events 548, 550, except that the base station 104 excludes or refrains from including, in the RRC reconfiguration message of events 549, 551, UL configuration parameters for UL communication with the base station 104 via the TRP 107-2. Instead, the base station 104 transmits 578, 580, to the UE 102 via the TRP 107-1, another RRC reconfiguration message that includes the UL configuration parameters for UL communication with the base station 104 via the TRP 107-2. In response, the UE 102 transmits 582, 584 an RRC reconfiguration complete message to the base station 104 via the TRP 107-1. In some implementations, the base station 104 includes the UL configuration parameters in a CellGroupConfig IE and includes the CellGroupConfig IE in the RRC reconfiguration message of events 578, 580. In some implementations, the base station 104 includes the UL configuration parameters in a BWP-UplinkDedicated IE and includes the BWP-UplinkDedicated IE in the RRC reconfiguration message.

The blocks 549, 551, 552, 554, 556, 578, 580, 582, and 584 are collectively referred to in FIG. 5B as a TRP configuration procedure 596B. After receiving the RRC reconfiguration message at event 538, performing the CSI resource configuration and CSI reporting procedure 594, or performing TRP configuration procedure 596B with the base station 104, the UE 102 receives 562, 564 the RS from the base station 104 via the TRP 107-2. After performing the TRP configuration procedure 596A with the base station 104, the UE 102 performs 598 the random access procedure with the base station 104 via the TRP 107-2.

Referring next to FIG. 5C, a scenario 500C is similar to the scenarios 500A and 500B with differences described below.

After transmitting 549, 550 the RRC reconfiguration message or receiving 552, 554 the RRC reconfiguration complete message, the base station 104 transmits 579, 581, to the UE 102 via the TRP 107-2, another RRC reconfiguration message that includes the UL configuration parameters for UL communication with the base station 104 via the TRP 107-2. The RRC reconfiguration message of events 579, 581 are similar to the RRC reconfiguration message of events 578, 580, except that the base station 104 transmits 579, 581 the RRC reconfiguration to the UE 102 via the TRP 107-2 instead of the TRP 107-1.

The blocks 549, 551, 552, 554, 556, 579, 581, 582, and 584 are collectively referred to in FIG. 5C as a TRP configuration procedure 596C.

Referring next to FIG. 5D, a scenario 500D is similar to the scenarios 500A, 500B, and 500C with differences described below.

After the UE 102 performs the TRP configuration procedure 596A, 596B or 596C with the base station 104, the UE 102 initiates 599 a random access procedure. In response to the initiation, the UE 102 transmits 566, 568 the second random access preamble to the base station 104 via TRP 107-2. In response, the base station 104 transmits 571, 573 the second random access response to the UE 102 via the TRP 107-1 instead of the TRP 107-2.

Referring next to FIG. 5E, a scenario 500E is similar to the scenarios 500A, 500B, 500C, and 500D with differences described below.

In some implementations, after receiving the RRC reconfiguration complete message at event 554, the base station 104 transmits 559, 561 a PDCCH order to the UE 102 via the TRP 107-1 to cause the UE 102 to initiate the random access procedure 598 or 599 with the base station 104 via the TRP 107-2, similar to the events 558, 560.

FIGS. 6-12 are flow diagrams depicting example methods that a UE (e.g., the UE 102) can implement to enable multiple TA value operations under multiple-TRP scenario. FIGS. 6-12 depict some methods in which the UE determines which TA value to apply for transmitting a UL transmission. The first TRP and second TRP described below can be the TRP 107-1 and TRP 107-2, for example. In another example, the first TRP and second TRP described below can be the TRP 107-1 and TRP 107-3.

Some general descriptions are given below, which can be applied for the following flow diagrams and/or embodiments.

In some implementations, the UE performs DL reception from and/or UL transmission to a first TRP (e.g., one of TRP 107-1, TRP 107-2, TRP 107-3, TRP 108-1, and/or TRP 108-2). In some such implementations, the UE performs DL reception from and/or UL transmission to a second TRP (e.g., one of TRP 107-1, TRP 107-2, TRP 107-3, TRP 108-1, and/or TRP 108-2). In some implementations, the first TRP is located in the serving cell. In further implementations, the second TRP is located in the serving cell. Alternatively, the second TRP is located in a neighboring cell. In some implementations, the second TRP is located in a neighboring cell or a non-serving cell, where the neighboring cell or non-serving cell is a cell with a PCI different from that of the serving cell.

In some implementations, the UE comprises or is equipped with one or more panels. In some implementations, some or all of the one or more panels are used and/or activated for DL reception (e.g., performed at the same time or same time interval). In further implementations, some or all of the one or more panels are used and/or activated for UL transmission (e.g., performed at the same time or same time interval). In some implementations, the set of used and/or activated panels for DL reception are at least partially the same as the set of used and/or activated panels for UL transmission. In further implementations, the set of used and/or activated panels for DL reception are at least partially different from the set of used and/or activated panels for UL transmission.

In some implementations, each TRP (e.g., TRP 107-1, TRP 107-2, TRP 107-3, TRP 108-1, and/or TRP 108-2) is associated with or identified by a TRP identifier. In some implementations, a base station (e.g., the base station 104 or 106) includes a TRP identifier in UL configuration(s) that the base station transmits to a UE (e.g., the UE 102) for UL transmission(s) via a TRP identified by the TRP identifier. In some implementations, the UL configuration(s) include DCI transmitted on a PDCCH, and/or PUSCH configuration, PUCCH configuration and/or SRS configuration included in an RRC message (e.g., RRC reconfiguration message or an RRC resume message) that the base station transmits to the UE. In some implementations, the UL transmission(s) include PUSCH transmission(s), PUCCH transmission(s), and/or SRS transmission(s). In some implementations, the base station includes a TRP identifier in DL configuration(s) that the base station transmits to the UE 102 for DL transmission(s) via a TRP identified by the TRP identifier. In some implementations, the DL configuration(s) include DCI transmitted on a PDCCH, and/or CSI resource configuration, PDSCH configuration(s) and/or PDCCH configuration(s) included in an RRC message (e.g., RRC reconfiguration message or an RRC resume message) that the base station transmits to the UE. In some implementations, the DL transmission(s) include CSI-RS transmission(s), SSB transmission(s), PDSCH transmission(s), and/or PDCCH transmission(s).

In other implementations, the base station does not transmit a TRP identifier to the UE and uses an implicit indication to indicate a TRP to the UE. In some implementations, the implicit indication is one of the following configuration parameters: a CORESETPoolIndex, a value or value candidate of a CORESETPoolIndex, a dataScramblingIdentityPDSCH, a dataScramblingIdentityPDSCH2-r16, or a PUCCH-ResourceGroup-r16. In such implementations, the UE derives a TRP (identifier) from the implicit indication. In some implementations, the base station transmits an RRC message (e.g., RRC reconfiguration message or an RRC resume message), including the configuration parameter, to the UE.

In some implementations, the base station configures or indicates to the UE a first TRP identifier. In some implementations, the UE derives a first TRP identifier and/or identifier value. In some implementations, the base station configures or indicates to the UE a second TRP identifier and/or identifier value. In some implementations, the UE derives a second TRP identifier and/or identifier value.

In some cases, the UE maintains a plurality of TA values. In some such implementations, the UE maintains a plurality of TA values, where all of the plurality of TA values are indicated or signaled to the UE. In further such implementations, the UE maintains a plurality of TA values, where all of the plurality of TA values are derived by the UE. In some implementations, the UE maintains a plurality of TA values, where at least one of some TA values are indicated or signaled to the UE and at least one of the remaining TA values are derived by the UE. In further implementations, the UE maintains or operates the plurality of TA values in a serving cell. In some implementations, the base station indicates or configures the UE respective ID for the plurality of TA values. In some implementations, the UE derives respective ID for the plurality of TA values. In some such implementations, each of the plurality of TA values has an individual ID. In some such cases, the UE maintains the plurality of TA values for or in a serving cell.

In some cases, the base station configures or activates, for the UE, a first set of serving cells. In some cases, the base station configures or activates, for the UE, a second set of serving cells. In some implementations, the first set of serving cells has the same serving cells elements as those of the second set of serving cells. In some implementations, the first set of serving cells has different serving cells elements from those of the second set of serving cells.

In some cases, the base station configures or activates, for the UE, a third set of serving cells. In some implementations, the third set of serving cells at least comprise the first set of serving cells. In further implementations, the third set of serving cells at least comprise the second set of serving cells. In some implementations, the third set of serving cells at least comprise the first set of serving cells and the second set of serving cells. In some implementations, the third set of serving cells are the union of the first set of serving cells and the second set of serving cells. In some implementations, the third set of serving cells are the intersection of the first set of serving cells and the second set of serving cells.

In some cases, the UE may maintain a first TA value, which is among the plurality of TA values. In some cases, the UE may maintain a second TA value, which is among the plurality of TA values. In some implementations, the first TA value may be associated with the first TRP. In some implementations, the second TA value may be associated with the second TRP.

Depending on the implementation, the first TA value: (i) applies for or is associated with the first set of serving cells, (ii) applies for or is associated with the first TRP, (iii) applies for or is associated with UL channel/RS transmission transmitted to the first TRP, and/or (iv) applies for or is associated with UL channel/RS transmission related to the first TRP identifier and/or identifier value.

Depending on the implementation, the second TA value: (i) applies for or is associated with the second set of serving cells, (ii) applies for or is associated with the second TRP, (iii) applies for or is associated with UL channel/RS transmission transmitted to the second TRP, and/or (iv) applies for or is associated with UL channel/RS transmission related to the second TRP identifier and/or identifier value.

In some cases, the base station indicates or configures, for the UE, an ID of the first TA value. In some cases, the UE derives an ID of the first TA value. In some cases, the base station indicates or configures, for the UE, an ID of the second TA value. In some cases, the UE derives an ID of the second TA value.

In some cases, the base station configures or indicates, for the UE, one or more TA group(s). In some implementations, one TA group (TAG) includes or is associated with one or more serving cell and/or indices. In some implementations, each serving cell included in or associated with the same TAG uses or is operated with the one or more TA values. In some implementations, one TAG includes or is associated with one or more TA values. In some implementations, the UE is indicated to or configured, or the UE derives, respective ID(s) for the one or more TA group(s). In some such implementations, each TAG has an individual ID.

In some cases, the base station configures or indicates, for the UE, a first TAG. In some implementations, the first TAG is among the one or more TA group(s). In some implementations, the first TA value or the ID of the first TA value is associated with or included in the first TAG.

In some cases, the base station configures or indicates, for the UE, a second TAG. In some implementations, the second TAG is among the one or more TA group(s). In some implementations, the second TA value or the ID of the second TA value is associated with or included in the second TAG.

In some cases, the first TA value and second TA value are associated with or included in the same TAG.

In some implementations, the first TAG is associated with the first TRP or the first TRP identifier and/or identifier value. In some implementations, the first TAG includes or is associated with the first set of serving cells. In some implementations, the first set of serving cells is configured with or associated with the first TRP or the first TRP identifier and/or identifier value. In some implementations, in each serving cell of the first set of serving cells, at least one CORESET is configured with or associated with CORESETPoolIndex #0.

In some implementations, the first TAG includes or is associated with one or more TA values, where the one or more TA values: (i) applies for or is associated with the first set of serving cells, (ii) applies for or is associated with the first TRP, (iii) applies for or is associated with UL channel/RS transmission related to the first TRP or the first TRP identifier and/or identifier value, and/or (iv) applies for or is associated with the third set of serving cells.

In some implementations, the second TAG is associated with the second TRP or the second TRP identifier and/or identifier value. In some implementations, the second TAG includes or is associated with a second set of serving cells. In some implementations, the second set of serving cells are configured with or associated with the second TRP or the second TRP identifier and/or identifier value. In some implementations, in each serving cell of the second set of serving cells, at least one CORESET is configured with or associated with CORESETPoolIndex #1.

In some implementations, the second TAG includes or is associated with one or more TA values, where the one or more TA values: (i) applies for or is associated with the second set of serving cells, (ii) applies for or is associated with the second TRP, (iii) applies for or is associated with UL channel/RS transmission related to the second TRP or the second TRP identifier and/or identifier value, and/or (iv) applies for or is associated with the third set of serving cells.

In some cases, the base station indicates or configures, for the UE, an ID of the first TAG. In some cases, the UE derives an ID of the first TAG. In some cases, the BS indicates or configures, for the UE, an ID of the second TAG. In some cases, the UE derives an ID of the second TAG.

In some cases, the base station indicates or configures, for the UE, a third TAG. In some implementations, the third TAG is among the one or more TA group(s). In some implementations, the UE has indicated to or configured, or the UE may derive, an ID of the third TAG.

In some implementations, the third TAG is associated with the first TRP or the first TRP identifier and/or identifier value. In some implementations, the third TAG is associated with the second TRP or the second TRP identifier and/or identifier value. In some implementations, the third TAG includes or is associated with the third set of serving cells.

In some implementations, the third TAG includes or is associated with one or more TA values. In some implementations, the third TAG includes or is associated with one or more TA values, where the one or more TA values include the first TA value and/or the second TA value.

In some implementations, if the base station indicates or configures, for the UE, the third TAG, the UE determines to expect at least one of the following: (i) all serving cells included in or associated with the third TAG are configured with a multiple-TRP (M-TRP) mode by the base station (e.g., the M-TRP mode is a single-DCI (S-DCI) M-TRP mode or multiple-DCI (M-DCI) M-TRP mode), (ii) all serving cells included in or associated with the third TAG are configured with CORESETPoolIndex by the base station, and/or (iii) all serving cells included in or associated with the third TAG are configured, by the base station, with or associated with the first TRP identifier and/or identifier value and the second TRP identifier and/or identifier value.

In some implementations, if the base station configures the third TAG for the UE, the base station performs one or some of the following: (i) configuring all serving cells included in or associated with the third TAG with an M-TRP mode, (e.g., the M-TRP mode is an S-DCI M-TRP mode or M-DCI M-TRP mode), (ii) configuring all serving cells included in or associated with the third TAG with CORESETPoolIndex, and/or (iii) configuring or associating all serving cells included in or associated with the third TAG with the first TRP identifier and/or identifier value and the second TRP identifier and/or value.

In some cases, the base station configures or indicates, for the UE, one or more primary TAGS (PTAGs). In some implementations, the base station configures or indicates, for the UE, two PTAGs. In some cases, the base station configures or indicates, for the UE, one or more secondary TAGs (STAGs).

In some cases, the first TAG is a PTAG. In some implementations, the first set of serving cells comprises a primary cell (PCell) or primary secondary cell (PSCell). In some implementations, the first TAG is a STAG. In some implementations, the first set of serving cells does not comprise a PCell or PSCell.

In some cases, the second TAG is a PTAG. In some implementations, the second set of serving cells comprises a PCell or PSCell. In some implementations, the second TAG is a STAG. In some implementations, the second set of serving cells does not comprise a PCell or PSCell.

In some cases, the third TAG is a PTAG. In some implementations, the third set of serving cells comprises a PCell or PSCell. In some implementations, the third TAG is a STAG. In some implementations, the third set of serving cells does not comprise a PCell or PSCell.

In some cases, the base station configures or indicates, for the UE, one or more Time Alignment Timer(s) (TAT(s)). In some implementations, the one or more TAT(s) are configured or indicated for an active BWP or in a serving cell. In some implementations, the base station configures or indicates, for the UE, a first TAT in the active BWP or in the serving cell. In some implementations, the base station configures or indicates, for the UE, a second TAT in the active BWP or in the serving cell. In some implementations, the UE maintains the first TAT. In some implementations, the UE maintains the second TAT. In some implementations, the base station similarly maintains the first TAT and/or second TAT.

In some implementations, the first TAT is associated with the first TAG. In further implementations, the first TAT is associated with or applied to the first set of serving cells. In some implementations, the second TAT is associated with the second TAG. In further implementations, the second TAT is associated with or applied to the second set of serving cells.

In some implementations, the base station configures or indicates, for the UE, an ID of the first TAT. In further implementations, the UE derives an ID of the first TAT. In some implementations, the base station configures or indicates, for the UE, an ID of the second TAT. In further implementations, the UE derives an ID of the second TAT.

In some cases, the base station configures or indicates, for the UE, a third TAT in the active BWP or in the serving cell. In some implementations, the third TAT is associated with or applied to the third set of serving cells. In some implementations, the UE maintains the third TAT. In some implementations, the base station similarly maintains the third TAT. In some implementations, the base station configures or indicates, for the UE, an ID of the third TAT. In further implementations, the UE derives an ID of the third TAT.

In some cases, the first TA value and the second TA value belong to or are associated with a same TAG (e.g., the third TAG). In some implementations, the ID of the first TA value and the ID of the second TA value are included in a same TAG (e.g., the third TAG). In some cases, the first TA value and the second TA value belong to or are associated with different TAGs (e.g., the first TAG and the second TAG). In some implementations, the ID of the first TA value and the ID of the second TA value are included in different TAGs (e.g., the first TAG and the second TAG).

In some cases, whether the first TA value is expired and whether the second TA value is expired are controlled by or associated with a same TAT (e.g., the third TAT). In further cases, whether the first TA value is expired and whether the second TA value is expired are controlled by or associated with different TATs (e.g., the first TAT and the second TAT).

In some cases, whether the first TAG is uplink time aligned and whether the second TAG is uplink time aligned are controlled by or associated with a same TAT (e.g., the third TAT). In further cases, whether the first TAG is uplink time aligned and whether the second TAG is uplink time aligned are controlled by or associated with different TATs (e.g., the first TAT and the second TAT).

In some cases, whether the first set of serving cells is uplink time aligned and whether the second set of serving cells is uplink time aligned are controlled by or associated with a same TAT (e.g., the third TAT). In further cases, whether the first set of serving cells is uplink time aligned and whether the second set of serving cells is uplink time aligned are controlled by or associated with different TATs (e.g., the first TAT and the second TAT).

In some cases, the base station configures or indicates, for the UE, to transmit a UL transmission. In some implementations, the UL transmission is associated with a TA value and/or a TAG. In further implementations, the UL transmission is applied to or associated with the first TA value or the second TA value. In some implementations, the base station indicates, to the UE, which TA value is associated with or applied to the UL transmission. In some implementations, the UE derives which TA value is associated with or applied to the UL transmission.

In some implementations, the UL transmission is one of the following: (i) a PUCCH resource; (ii) an SRS resource, for example: (a) an SRS resource for UL CB transmission, (b) an SRS resource for UL NCB transmission, (c) an SRS resource for BM, (d) an SRS resource for antenna switching, (e) an SRS resource for carrier switching, and/or (f) an SRS resource for positioning; and/or (iii) a PUSCH, for example: (a) a configured UL grant and/or (b) a dynamically scheduled PUSCH resource.

In some implementations, time domain behavior of the UL transmission is one of: (i) periodic, (ii) semi-persistent, and/or (iii) aperiodic.

In some implementations, the base station configures, for the UE, a first TAG and a second TAG for UL transmissions to the first TRP and second TRP, respectively. In some implementations, the base station transmits, to the UE, a first RRC message and a second RRC message including a first TAG configuration and a second TAG configuration to configure the first TAG and second TAG, respectively. In some implementations, the first TAG configuration and second TAG configuration include a first TAG ID and a second TAG ID to identify the first TAG and second TAG, respectively. In some implementations, the first TAG configuration and second TAG configuration include a timer value of/for the first TAT and a timer value of/for the second TAT for the first TAG and second TAG, respectively. In some implementations, the first RRC message and second RRC message are the same RRC message (e.g., the same instance) or different RRC messages (e.g., different instances or different types of RRC messages). In some implementations, the first and second RRC messages are RRC setup, RRC reconfiguration, and/or RRC resume messages. The UE associates the first TA value and second TA value with the first TAG and second TAG, respectively. In some implementations, the first TAG is associated with the first TRP or the first TRP identifier and/or identifier value. In some implementations, the first TAG is associated with a particular serving cell operated by the first TRP and configured for the UE. In some implementations, the first TAG is associated with additional serving cell(s) operated by the first TRP and configured for the UE. In some implementations, the base station indicates or configures the association(s) in the first RRC message. In some implementations, the second TAG is associated with the second TRP or the second TRP identifier and/or identifier value. In some implementations, the second TAG is associated with the particular serving cell or non-serving cell, and the base station indicates or configures the association in the second RRC message.

In other implementations, the base station configures, for the UE, a single TAG (e.g., a third TAG) for UL transmissions to the first TRP and second TRP. In some implementations, the base station transmits, to the UE, a first RRC message (e.g., RRC setup, RRC reconfiguration and/or RRC resume message), including a single TAG configuration to configure the TAG. In some implementations, the TAG configuration includes a single TAG ID to identify the TAG. In some implementations, the TAG configuration includes a timer value of/for the first TAT and a timer value of/for the second. In further implementations, the TAG configuration includes a timer value of/for the first TAT, and the base station transmits a second RRC message (e.g., RRC setup, RRC reconfiguration, and/or RRC resume message), including a timer value of the second TAT. The UE associates the first TA value and second TA value with the TAG. In some implementations, the TAG is associated with (i) the first TRP or the first TRP identifier and/or identifier value and (ii) the second TRP or the second TRP identifier. In some implementations, the TAG is associated with a particular serving cell operated by the first TRP and configured for the UE. In some implementations, the TAG is associated with additional serving cell(s) operated by the first TRP and configured for the UE. In some implementations, the base station indicates or configures the association(s) in the first RRC message. In some implementations, the TAG is associated with the second TRP or the second TRP identifier and/or identifier value. In some implementations, the TAG is associated with the particular serving cell or non-serving cell, and the base station indicates or configures the association in the second RRC message.

In some implementations, the base station configures that the particular serving cell is associated with the first TRP or the first TRP identifier and/or identifier value. In some implementations, the base station configures a first control resource set (CORESET) associated with the particular serving cell or first TRP. In further implementations, the base station configures CORESETPoolIndex #0 to identify the first CORESET. In some implementations, the base station transmits, to the UE, a third RRC message (e.g., an RRC setup message, an RRC reconfiguration message, or an RRC resume message) configuring the first CORESET and/or including the CORESETPoolIndex #0. Thus, the UE monitors a PDCCH on the first CORESET to receive DCIs from the base station, which implies that the UE monitors a PDCCH or receives DCIs via the first TRP from the base station (i.e., from the first TRP). In some such cases, the UE determines that CORESETPoolIndex #0 indicates a particular TRP (i.e., the first TRP) of the base station.

In some implementations, the base station configures a particular serving cell to be associated with the second TRP or the second TRP identifier and/or identifier value. In other implementation, the second TAG is associated with a non-serving cell, and the base station indicates or configures the association in the second RRC message. In some implementations, the base station configures the non-serving cell associated with the second TRP or the second TRP identifier and/or identifier value. In some implementations, the base station configures a second CORESET to be associated with the particular serving cell, non-serving cell, or second TRP. In further implementations, the base station configures CORESETPoolIndex #1 to identify the second CORESET. In some implementations, the base station transmits, to the UE, a third RRC message (e.g., an RRC setup message, an RRC reconfiguration message, or an RRC resume message), configuring the second CORESET and/or including the CORESETPoolIndex #1. Thus, the UE monitors a PDCCH on the second CORESET to receive DCIs from the base station, which implies that the UE monitors a PDCCH or receives DCIs via the second TRP from the base station (i.e., from the second TRP). In some such implementations, the UE determines that CORESETPoolIndex #1 indicates a particular TRP (i.e., the second TRP).

In some implementations, the base station configures a first ID for identifying the first TA value for the UE, in addition to the TAG ID(s) described above. In some implementations, the base station includes the first ID in the RRC message described above. In further implementations, the base station includes the first ID in the first TA command. In other implementations, the UE derives or determines the first ID and associates the first ID with the first TA value. Similarly, the base station configures a second ID for identifying the second TA value for the UE, in addition to the TAG ID(s) described above. In some implementations, the base station includes the second ID in the RRC message described above. In further implementations, the base station includes the second ID in the second TA command. In other implementations, the UE derives or determines the second ID and associates the second ID with the second TA value.

More generally, in some implementations, the base station configures or indicates, to the UE, a first index for or associated with the first TRP. In some implementations, the UE derives or determines the first index. In some implementations, the first index is one of: (i) the first TRP identifier and/or identifier value, (ii) an ID of the first TAG, (iii) an ID of the first TA value, and/or (iv) an ID of the first TAT.

More generally, in further implementations, the base station configures or indicates, to the UE, a second index for/associated with the second TRP. In some implementations, the UE derives the second index. In some implementations, the second index is one of: (i) the second TRP identifier and/or identifier value, (ii) an ID of the second TAG, (iii) an ID of the second TA value, and/or (iv) an ID of the second TAT.

Turning first to FIG. 6, a UE (e.g., the UE 102) implements an example method 600 to determine which TA value (e.g., between a first TA value and a second TA value) to apply when transmitting a UL transmission.

The method 600 begins at block 602, where the UE performs DL and/or UL communications with a base station (e.g., events 504, 506, 508, 510, 512, 514, 516, 518, 590, 522, 524, 526, 528, 532, 534, 592, 536, 538, 540, 542, 544, 546, 594, 549, 551, 552, 554, 556, 562, 564). At block 604, the UE receives a configuration enabling two timing advance values from the base station (e.g., events 548, 550, 596A, 578, 580, 596B, 579, 581, 596C). At block 606, the UE receives a first TA value and a second TA value from the base station (e.g., events 516, 518, 570, 571, 572, 573, 590, 598, 599). At block 608, the UE determines to transmit a UL transmission (e.g., PUSCH transmission, PUCCH transmission or SRS). At block 610, the UE determines whether the UL transmission is associated with the first TA value or the second TA value. If the UE determines that the UL transmission is associated with the first TA value, the flow proceeds to block 622. At block 622, the UE transmits the UL transmission to the base station using the first TA value (e.g., events 520, 590). If the UE determines that the UL transmission is associated with the second TA value, the flow proceeds to block 626. At block 626, the UE transmits the UL transmission to the base station using the second TA value (e.g., events 574, 598, 599).

More detailed descriptions of elements of the method 600 are described herein, particularly with regard to the general description above. For example, in some implementations: (i) the first TA value and the second TA value shown at block 606 are described in the description of the first TA value and the second TA value described with regard to the general description above and/or (ii) the UL transmission shown at block 608 is described in the description of the UL transmission described with regard to the general description above.

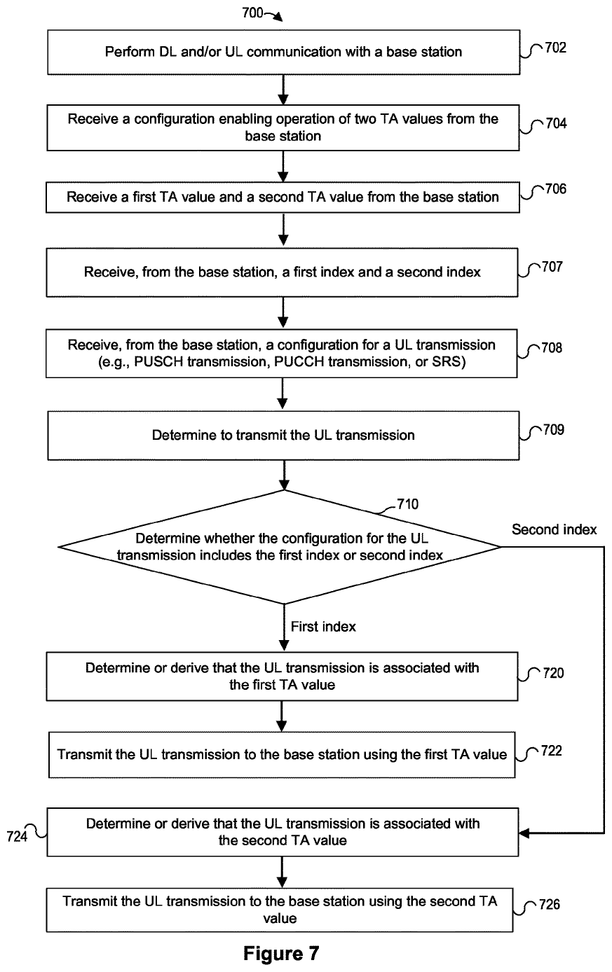

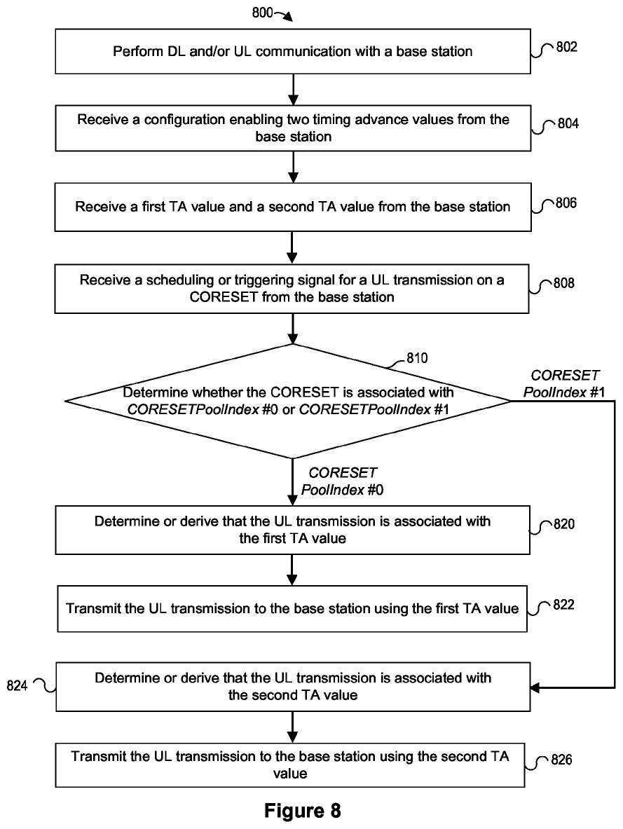

Turning next to FIG. 7, a UE (e.g., the UE 102) implements an example method 700 to determine which TA value (e.g., the first TA value or the second TA value) to apply when transmitting a UL transmission.

The method 700 begins at block 702. Blocks 702, 704, 706, 722, and 726 are similar to blocks 602, 604, 606, 622, and 626. At block 707, the UE receives, from the base station, a first index and a second index. At block 708, the UE receives, from the base station, a configuration for a UL transmission (e.g., PUSCH transmission, PUCCH transmission, or SRS) (e.g., events 506, 518, 528, 538, 550, 551, 564, 580, 581). At block 709, the UE determines to transmit the UL transmission. At block 710, the UE determines whether the configuration for the UL transmission includes the first index or second index. If the UE determines that the configuration for the UL transmission includes the first index, the flow proceeds to block 720. At block 720, the UE determines or derives that the UL transmission is associated with the first TA value. If the UE determines that the configuration for the UL transmission includes the second index, the flow proceeds to block 724. At block 724, the UE determines or derives that the UL transmission is associated with the second TA value.

Similar to the method 600, more detailed descriptions of elements of the method 700 are generally detailed above.

In some cases, the UE determines that (a) the UL transmission is transmitted by applying the first TA value or (b) the UL transmission is associated with the first TA value, based on one of the following: (i) the UL transmission or a configuration for the UL transmission includes or is associated with one of the first TA value, the first TAG, the first TAT, or the first TRP, and/or (ii) the UL transmission or a configuration for the UL transmission includes or is associated with the first index. In some such implementations, the UL transmission is one of the following: (i) a PUSCH with configured UL grant, (ii) a P-SRS or SP-SRS, (iii) a P-CSI report or SP-CSI report, (iv) a P-CSI report or SP-CSI report carried or transmitted on a PUCCH or PUSCH resource, and/or (v) a scheduling request.

In further cases, the UE determines that (a) the UL transmission is transmitted by applying the second TA value or (b) the UL transmission is associated with the second TA value, based on one of the following: (i) the UL transmission or a configuration for the UL transmission includes or is associated with one of the second TA value, the second TAG, the second TAT, or the second TRP, and/or (ii) the UL transmission or a configuration for the UL transmission includes or is associated with the second index. In some such implementations, the UL transmission is one of the following: (i) a PUSCH with configured UL grant, (ii) a P-SRS or SP-SRS, (iii) a P-CSI report or SP-CSI report, (iv) a P-CSI report or SP-CSI report carried or transmitted on a PUCCH or PUSCH resource, and/or (v) a scheduling request.

In still further cases, the configuration for the UL transmission refers to at least one of the following: (i) if the UL transmission is a PUCCH resource, the configuration can refer to: (a) PUCCH-config, (b) resourceSetToAddModList or resourceSetToReleaseList, (c) resourceToAddModList or resourceToReleaseList, (d) schedulingRequestResourceToAddModList or schedulingRequestResourceToReleaseList, (e) resourceToAddModListExt-v1610, (f) schedulingRequestResourceToAddModListExt-v1610 or schedulingRequestResourceToAddModListExt-v1700, (g) PUCCH-ResourceSet, (h) resourceList, (i) PUCCH-Resource or PUCCH-ResourceExt-v1610, and/or (j) PUCCH-ConfigCommon; (ii) if the UL transmission is an SRS resource, the configuration can refer to: (a) SRS-Config, (b) srs-ResourceSetToAddModList or srs-ResourceSetToReleaseList, (c) srs-44 ResourceToAddModList or srs-ResourceToReleaseList, (d) srs-ResourceSetToAddModListDCI-0-2-r16 or srs-ResourceSetToReleaseListDCI-0-2-r16, (e) srs-PosResourceSetToAddModList-r16 or srs-PosResourceSetToReleaseList-r16, (f) srs-PosResourceToAddModList-r16 or srs-PosResourceToReleaseList-r16, (g) SRS-ResourceSet, (h) srs-ResourceIdList, (i) SRS-PosResourceSet-r16, (j) srs-PosResourceIdList-r16, (k) SRS-Resource, (1) SRS-PosResource-r16, and/or (m) SRS-CarrierSwitching; (iii) if the UL transmission is a dynamically scheduled PUSCH, the configuration can refer to: (a) PUSCH-Config, (b) pusch-TimeDomainAllocationList, (c) pusch-TimeDomainAllocationListDCI-0-1-r16 or pusch-TimeDomainAllocationListDCI-0-2-r16, (d) pusch-TimeDomainAllocationListForMultiPUSCH-r16 or pusch-TimeDomainAllocationListForMultiPUSCH-r17, (e) pusch-TimeDomainAllocationListDCI-0-1-r17 or pusch-TimeDomainAllocationListDCI-0-2-r17, (f) PUSCH-ConfigCommon, and/or (g) PUSCH-ServingCellConfig; and/or (iv) if the UL transmission is a configured UL grant, the configuration can refer to: (a) ConfiguredGrantConfig, (b) rrc-ConfiguredUplinkGrant, (c) timeDomainAllocation, and/or (d) cg-SDT-Configuration-r17.

Turning next to FIG. 8, a UE (e.g., the UE 102) implements an example method 800 to determine which TA value (e.g., the first TA value or the second TA value) to apply when transmitting a UL transmission.

The method 800 begins at block 802. Blocks 802, 804, 806, 820, 822, 824, and 826 are similar to blocks 702, 704, 706, 720, 722, 724, and 726. At block 808, the UE receives a scheduling or triggering signal for a UL transmission on a CORESET from the base station (e.g., event 550). At block 810, the UE determines whether the CORESET is associated with CORESETPoolIndex #0 or CORESETPoolIndex #1. If the UE determines that the CORESET is associated with CORESETPoolIndex #0, the flow proceeds to block 820. If the UE determines that the CORESET is associated with CORESETPoolIndex #1, the flow proceeds to block 824.

Similar to the method 600 and 700, more detailed descriptions of elements of the method 800 described generally herein.

In some cases, the UE determines that (i) the UL transmission is transmitted by applying the first TA value or (ii) the UL transmission is associated with the first TA value, if or when the UL transmission is scheduled or triggered by a DL transmission configured or associated with the first index. In some implementations, the UE determines such at block 810. In some such implementations, the DL transmission is one of the following: (i) a CORESET, (ii) a DCI, (iii) a search space, (iv) a PDSCH, and/or (v) a CSI-RS. In further such implementations, the UL transmission is one of the following: (i) a dynamically scheduled PUSCH, (ii) an AP-SRS, (iii) an AP-CSI report, and/or (iv) an AP-CSI report carried or transmitted on a PUCCH or PUSCH resource.

In some cases, the UE determines that (i) the UL transmission is transmitted by applying the first TA value or (ii) the UL transmission is associated with the first TA value, if or when the UL transmission is associated with or in response to a DL transmission configured or associated with the first index. In some implementations, the UE determines such at block 810. In some such implementations, the DL transmission is one of the following: (i) a CORESET, (ii) a DCI, (iii) a search space, (iv) a PDSCH, and/or (v) a CSI-RS. In further such implementations, the UL transmission is a PUCCH resource indicated by a DCI scheduling a PDSCH. As an example, the UL transmission is a PUCCH resource associated with or in response to a PDSCH, where the PDSCH is scheduled by a DCI from a CORESET with CORESETPoolIndex #0. The PUCCH resource is indicated by the DCI. For some such examples, the PUCCH resource is transmitted by applying the first TA value.

In some cases, the UE determines that (i) the UL transmission is transmitted by applying the second TA value or (ii) the UL transmission is associated with the second TA value, if or when the UL transmission is scheduled or triggered by a DL transmission configured or associated with the second index. In some implementations, the UE determines such at block 810. In some such implementations, the DL transmission is one of the following: (i) a CORESET, (ii) a DCI, (iii) a search space, (iv) a PDSCH, and/or (v) a CSI-RS. In further such implementations, the UL transmission is one of the following: (i) a dynamically scheduled PUSCH, (ii) an AP-SRS, (iii) an AP-CSI report, and/or (iv) an AP-CSI report carried or transmitted on a PUCCH or PUSCH resource.

In some cases, the UE determines that (i) the UL transmission is transmitted by applying the second TA value or (ii) the UL transmission is associated with the second TA value, if or when the UL transmission is associated with or in response to a DL transmission configured or associated with the second index. In some implementations, the UE determines such at block 810. In some such implementations, the DL transmission is one of the following: (i) a CORESET, (ii) a DCI, (iii) a search space, (iv) a PDSCH, and/or (v) a CSI-RS. In further such implementations, the UL transmission is a PUCCH resource indicated by a DCI scheduling a PDSCH. As an example, the UL transmission is a PUCCH resource associated with or in response to a PDSCH, where the PDSCH is scheduled by a DCI from a CORESET with CORESETPoolIndex #1. In further implementations, the PUCCH resource is indicated by the DCI. In some such examples, the PUCCH resource is transmitted by applying the second TA value.

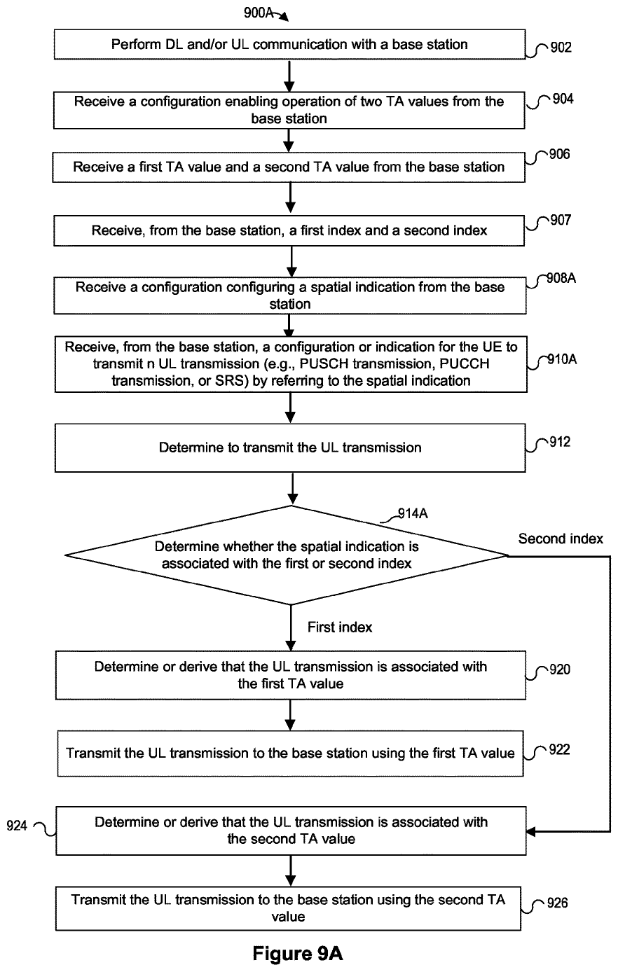

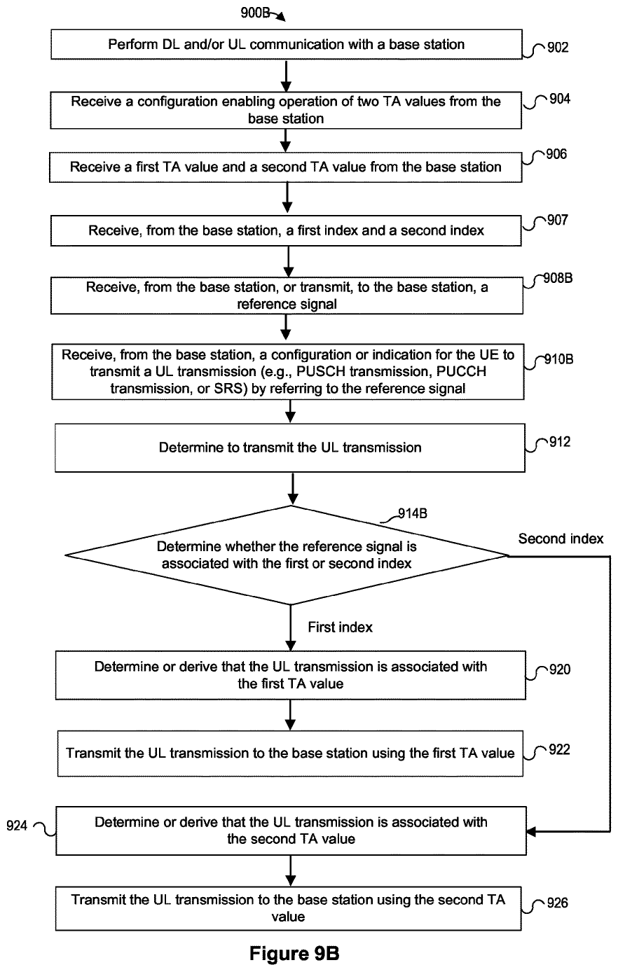

Turning next to FIG. 9A, a UE (e.g., the UE 102) implements an example method 900A to determine which TA value (e.g., the first TA value or the second TA value) to apply when transmitting a UL transmission.

The method 900A begins at block 902. Blocks 902, 904, 906, 920, 922, 924, and 926 are similar to blocks 702, 704, 706, 720, 722, 724, and 726. At block 907, the UE receives, from the base station, a first index and a second index. At block 908A, the UE receives a configuration configuring a spatial indication from the base station. At block 910A, the UE receives, from the base station, a configuration that configures the UE or indication that indicates to the UE to transmit a UL transmission (e.g., PUSCH transmission, PUCCH transmission, or SRS) by referring to the spatial indication (e.g., events 506, 518, 528, 538, 550, 551, 564, 580, 581). At block 912, the UE determines to transmit the UL transmission. At block 914A, the UE determines whether the spatial indication is associated with the first or second index. If the UE determines that the spatial indication is associated with the first index, the flow proceeds to block 920. If the UE determines that the spatial indication is associated with the second index, the flow proceeds to block 924.

FIG. 9B illustrates an example method 900B similar to the scenario 900A illustrated in FIG. 9A, except with regard to blocks 908B, 910B, and 914B instead of 908A, 910A, and 914A. At block 908B, the UE receives, from the base station, or transmits, to the base station, a reference signal. At block 910B, the UE receives, from the base station, a configuration that configures the UE or an indication that indicates to the UE to transmit a UL transmission (e.g., PUSCH transmission, PUCCH transmission, or SRS) by referring to the reference signal (e.g., events 506, 518, 528, 538, 550, 551, 564, 580, 581). At block 914B, the UE determines whether the reference signal is associated with the first or second index. If the UE determines that the reference signal is associated with the first index, the flow proceeds to block 920. If the UE determines that the reference signal is associated with the second index, the flow proceeds to block 924.

Similar to methods 600, 700, and 800, more detailed descriptions of elements of the methods 900A and 900B are generally detailed above.

In some cases, the UE receives an indication or configuration of a spatial indication. In some implementations, the spatial indication is associated with or includes an ID of spatial indication.

In some cases, the UE determines that (i) the UL transmission is transmitted by applying the first TA value or (ii) the UL transmission is associated with the first TA value, if or when at least one of the following occurs: (i) the base station configures or indicates to the UE to transmit the UL transmission by spatial transmission filters/parameters derived from a spatial indication, where the spatial indication is associated with one of the first TA value, the first TAG, the first TAT, or the first TRP, (ii) the base station configures or indicates to the UE to transmit the UL transmission by spatial transmission filters/parameters derived from a spatial indication, where the spatial indication is associated with or includes the first index, (iii) the base station configures or indicates to the UE to transmit the UL transmission by spatial transmission filters/parameters derived from a reference signal, where the reference signal is associated with one of the first TA value, the first TAG, the first TAT, or the first TRP, and/or (iv) the base station configures or indicates to the UE to transmit the UL transmission by spatial transmission filters/parameters derived from a reference signal, where the reference signal is associated with or includes the first index.

In some cases, the UE determines that (i) the UL transmission is transmitted by applying the second TA value or (ii) the UL transmission is associated with the second TA value, if or when at least one of the following occurs: (i) the base station configures or indicates to the UE to transmit the UL transmission by spatial transmission filters/parameters derived from a spatial indication, where the spatial indication is associated with one of the second TA value, the second TAG, the second TAT or the second TRP, (ii) the base station configures or indicates to the UE to transmit the UL transmission by spatial transmission filters/parameters derived from a spatial indication, where the spatial indication is associated with or includes the second index, (iii) the base station configures or indicates to the UE to transmit the UL transmission by spatial transmission filters/parameters derived from a reference signal, where the reference signal is associated with one of the second TA value, the second TAG, the second TAT or the second TRP, and/or (iv) the base station configures or indicates to the UE to transmit the UL transmission by spatial transmission filters/parameters derived from a reference signal, where the reference signal is associated with or includes the second index.

In some cases, the spatial indication is or comprises one of the following: (i) a spatial relation or a spatial relation info or a spatial relation information; (ii) a UL TCI; (iii) a joint TCI; (iv) spatialRelationInfo or SpatialRelationInfo-PDC-r17; (v) spatialRelationInfoPos-r16, where, in some implementations, the UL transmission is related to positioning; (vi) PUCCH-SpatialRelationInfo or PUCCH-SpatialRelationInfoExt-r16; (vii) SRS-SpatialRelationInfo; (viii) SRS-SpatialRelationInfoPos-r16, where, in some implementations, the UL transmission is related to positioning; (ix) DLorJoint-TCIState-r17; and/or (x) UL-TCIState-r17.

In some cases, the reference signal is one of the following: (i) an SSB, (ii) a CSI-RS, (iii) an SRS, (iv) an SSB from a neighboring cell, and/or (v) a DL PRS or DL PRS for propagation delay compensation (PDC).

In some implementations, a spatial indication including the first index or the second index means that the configuration for the spatial indication includes or comprises the first index or the second index. In further implementations, a reference signal including the first index or the second index means that the configuration for the reference signal includes or comprises the first index or the second index.

In some cases, the base station configures for or indicates to the UE a first list. In some implementations, the first list comprises one or more spatial indications. In some implementations, the first list comprises one or more IDs of spatial indications.

In some cases, the BS configures for or indicates to the UE a second list. In some implementations, the second list comprises one or more spatial indications. In some implementations, the second list comprises one or more IDs of spatial indications.

In some implementations, the first list is associated with or includes the first TA value or an ID of the first TA value. In some implementations, the first list is associated with or includes the first TAG or an ID of the first TAG. In some implementations, the first list is associated with or includes the first TAT or an ID of the first TAT. In some implementations, the first list is associated with or includes the first TRP or the first TRP identifier and/or identifier value.

In some implementations, the second list is associated with or includes the second TA value or an ID of the second TA value. In some implementations, the second list is associated with or includes the second TAG or an ID of the second TAG. In some implementations, the second list is associated with or includes the second TAT or an ID of the second TAT. In some implementations, the second list is associated with or includes the second TRP or the second TRP identifier and/or identifier value.

In some cases, the base station configures for or indicates to the UE a first resource list. In some implementations, the first resource list comprises one or more reference signal. In some implementations, the first list comprises one or more IDs of the reference signals.

In some cases, the base station configures for or indicates to the UE a second resource list. In some implementations, the second resource list comprises one or more reference signals. In some implementations, the second list comprises one or more IDs of the reference signals.

In some implementations, the first resource list is associated with or includes the first TA value or an ID of the first TA value. In some implementations, the first resource list is associated with or includes the first TAG or an ID of the first TAG. In some implementations, the first resource list is associated with or includes the first TAT or an ID of the first TAT. In some implementations, the first resource list is associated with or includes the first TRP or the first TRP identifier and/or identifier value.

In some implementations, the second resource list is associated with or includes the second TA value or an ID of the second TA value. In some implementations, the second resource list is associated with or includes the second TAG or an ID of the second TAG. In some implementations, the second resource list is associated with or includes the second TAT or an ID of the second TAT. In some implementations, the second resource list is associated with or includes the second TRP or the second TRP identifier and/or identifier value.

In some cases, the UE determines that (i) the UL transmission is transmitted by applying the first TA value or (ii) the UL transmission is associated with the first TA value, if or when at least one of the following occurs: (i) the base station configures or indicates to the UE to transmit the UL transmission by spatial transmission filters/parameters derived from a spatial indication, where the spatial indication or its ID is associated with or comprised in the first list, and/or (ii) the base station configures or indicates to the UE to transmit the UL transmission by spatial transmission filters/parameters derived from a reference signal, where the reference signal or its ID is associated with or comprised in the first resource list.

In some cases, the UE determines that (i) the UL transmission is transmitted by applying the second TA value or (ii) the UL transmission is associated with the second TA value, if or when at least one of the following occurs: (i) the base station configures or indicates to the UE to transmit the UL transmission by spatial transmission filters/parameters derived from a spatial indication, where the spatial indication or its ID is associated with or comprised in the second list, and/or (ii) the base station configures or indicates to the UE to transmit the UL transmission by spatial transmission filters/parameters derived from a reference signal, where the reference signal or its ID is associated with or comprised in the second resource list.

In some implementations, the first list and/or the second list are one of the following or are modified from one of the following: (i) spatialRelationInfoToAddModList or spatialRelationInfoToAddModListExt-v1610; where the first list is spatialRelationInfoToAddModList or spatialRelationInfoToAddModList1-r18, the second list may be spatialRelationInfoToAddModList-r18 or spatialRelationInfoToAddModList2-r18, and/or the first list and/or the second list is configured in a configuration (e.g., PUCCH-Config); (ii) ul-TCIState-ToAddModList-r17, where the first list is ul-TCIState-ToAddModList-r17 or ul-TCIState-ToAddModList1-r18, the second list is ul-TCIState-ToAddModList-r18 or ul-TCIState-ToAddModList2-r18, and/or the first list and/or the second list are configured in a configuration (e.g., BWP-UplinkDedicated); and/or (iii) dl-orJoint-TCIState-ToAddModList-r17, where the first list is dl-orJoint-TCIState-ToAddModList-r17 or dl-orJoint-TCIState-ToAddModList1-r18, the second list is dl-orJoint-TCIState-ToAddModList-r18 or dl-orJoint-TCIState-51 ToAddModList2-r18, and/or the first list and/or the second list are configured in a configuration (e.g., PDSCH-Config).

In some implementations, the first resource list and/or the second resource list are one of the following or are modified from one of the following: (i) srs-ResourceSetToAddModList, (ii) srs-ResourceToAddModList, (iii) srs-ResourceSetToAddModListDCI-0-2-r16, (iv) srs-PosResourceSetToAddModList-r16, (v) srs-PosResourceToAddModList-r16, (vi) SRS-ResourceSet, (vii) srs-ResourceIdList, (viii) SRS-PosResourceSet, (ix) srs-PosResourceIdList-r16, (x) nzp-CSI-RS-ResourceToAddModList, (xi) nzp-CSI-RS-ResourceSetToAddModList, (xii) csi-SSB-ResourceSetToAddModList, (xiii) csi-ResourceConfigToAddModList, (xiv) CSI-ResourceConfig, (xv) csi-RS-ResourceSetList, (xvi) nzp-CSI-RS-SSB, (xvii) nzp-CSI-RS-ResourceSetList, (xviii) csi-SSB-ResourceSetList, (xix) csi-SSB-ResourceSetListExt-r17, (xx) csi-RS-CellList-Mobility, (xxi) csi-rs-ResourceList-Mobility, (xxii) CSI-SSB-ResourceSet, (xxiii) NZP-CSI-RS-ResourceSet, (xxiv) nzp-CSI-RS-Resources, (xxv) an SSB list or SSB set, and/or (xxvi) a list or set of SSB transmitted from a neighboring cell.

In some implementations, the first list and/or the second list are included in or associated with a TAG or a TAG configuration. In some implementations, the first resource list and/or the second resource list are included in or associated with a TAG or a TAG configuration.

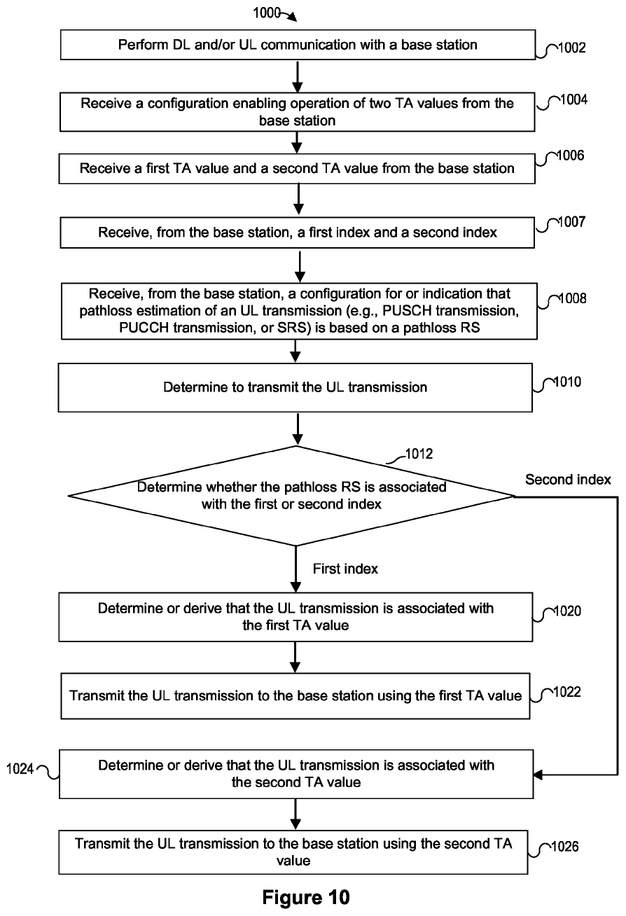

Turning next to FIG. 10, a UE (e.g., the UE 102) implements an example method 1000 to determine which TA value (e.g., the first TA value or the second TA value) to apply when transmitting a UL transmission.

The method 1000 begins at block 1002. Blocks 1002, 1004, 1006, 1020, 1022, 1024, and 1026 are similar to blocks 702, 704, 706, 720, 722, 724, and 726. At block 1007, the UE receives, from the base station, a first index and a second index. At block 1008, the UE receives, from the base station, an indication that a pathloss estimation of a UL transmission (e.g., PUSCH transmission, PUCCH transmission, or SRS) is based on a pathloss RS. At block 1010, the UE determines to transmit the UL transmission. At block 1012, the UE determines whether the pathloss RS is associated with the first or second index. If the UE determines that the pathloss RS is associated with the first index, the flow proceeds to block 1020. If the UE determines that the pathloss RS is associated with the second index, the flow proceeds to block 1024.

Similar to methods 600-900B, more detailed descriptions of elements of the method 1000 are generally detailed above.

In some cases, the base station configures for or indicates to the UE a pathloss reference signal. In some implementations, the pathloss reference signal is associated with or includes an ID of the pathloss reference signal.

In some cases, the UE may determines that (i) the UL transmission is transmitted by applying the first TA value or (ii) the UL transmission is associated with the first TA value, if or when at least one of the following occurs: (i) the base station configures or indicates to the UE to estimate or determine pathloss of the UL transmission by using a pathloss reference signal, where the pathloss reference signal is associated with one of the first TA value, the first TAG, the first TAT, or the first TRP, and/or (ii) the base station configures or indicates to the UE to estimate or determine pathloss of the UL transmission by using a pathloss reference signal, where the pathloss reference signal is associated with or includes the first index.

In some cases, the UE determines that (i) the UL transmission is transmitted by applying the second TA value or (ii) the UL transmission is associated with the second TA value, if or when at least one of the following occurs: (i) the base station configures or indicates to the UE to estimate or determine pathloss of the UL transmission by using a pathloss reference signal, where the pathloss reference signal is associated with one of the second TA value, the second TAG, the second TAT, or the second TRP, and/or (ii) the base station configures or indicates to the UE to estimate or determine pathloss of the UL transmission by using a pathloss reference signal, where the pathloss reference signal is associated with or includes the second index.

In some implementations, a pathloss reference signal including the first index or the second index means that a configuration for the reference signal includes or comprises the first index or the second index.

In some implementations, the pathloss RS or configuration for the pathloss RS is or comprises one of the following: (i) PUSCH-PathlossReferenceRS or PUSCH-PathlossReferenceRS-r16, (ii) PUCCH-PathlossReferenceRS or PUCCH-PathlossReferenceRS-r16, (iii) PathlossReferenceRS-Config or PathlossReferenceRS-r16 or pathlossReferenceRS-Pos-53 r16, (iv) an SSB or SSB index, (v) a CSI-RS or CSI-RS resource index, (vi) SSB-InfoNcell-r16, (vii) a DL PRS or a DL PRS for PDC or DL PRS resource index, and/or (viii) DL-PRS-Info-r16.

In some cases, the base station configures for or indicates to the UE a first pathloss list. In some implementations, the first pathloss list comprises one or more pathloss reference signal. In some implementations, the first pathloss list comprises one or more ID of pathloss reference signal.

In some cases, the base station configures for or indicates to the UE a second pathloss list. In some implementations, the second pathloss list comprises one or more pathloss reference signal. In some implementations, the second pathloss list comprises one or more ID of pathloss reference signal.

In some implementations, the first pathloss list is associated with or includes the first TA value or an ID of the first TA value. In some implementations, the first pathloss list is associated with or includes the first TAG or an ID of the first TAG. In some implementations, the first pathloss list is associated with or includes the first TAT or an ID of the first TAT. In some implementations, the first pathloss list is associated with or includes the first TRP or the first TRP identifier and/or identifier value.

In some implementations, the second pathloss list is associated with or includes the second TA value or an ID of the second TA value. In some implementations, the second pathloss list is associated with or includes the second TAG or an ID of the second TAG. In some implementations, the second pathloss list is associated with or includes the second TAT or an ID of the second TAT. In some implementations, the second pathloss list is associated with or includes the second TRP or the second TRP identifier and/or identifier value.

In some cases, the UE determines that (i) the UL transmission is transmitted by applying the first TA value or (ii) the UL transmission is associated with the first TA value, if or when the base station configures or indicates to the UE to estimate or determine pathloss of the UL transmission is performed by using a pathloss reference signal, where the pathloss reference signal is associated with or comprised in the first pathloss list.

In some cases, the UE determines that (i) the UL transmission is transmitted by applying the second TA value or (ii) the UL transmission is associated with the second TA value, if or when the base station configures or indicates to the UE to estimate or determine pathloss of the UL transmission is performed by using a pathloss reference signal, where the pathloss reference signal is associated with or comprised in the second pathloss list.

In some implementations, the first pathloss list and/or the second pathloss list is one of the following or is modified from one of the following: (i) pathlossReferenceRSToAddModList or pathlossReferenceRSToAddModListSizeExt-v1610 where, for example, the first pathloss list is pathlossReferenceRSToAddModList or pathlossReferenceRSToAddModList1-r18, the second pathloss list is pathlossReferenceRSToAddModList-r18 or pathlossReferenceRSToAddModList2-r18, and/or the first pathloss list and/or the second pathloss list is configured in a configuration (e.g., PUSCH-config or PUSCH-PowerControl or PUSCH-PowerControl-v1610); (ii) pathlossReferenceRSs where, for example, the first pathloss list is pathlossReferenceRSs or pathlossReferenceRSs1-r18, the second pathloss list is pathlossReferenceRSs-r18 or pathlossReferenceRSs2-r18, and/or the first pathloss list and/or the second pathloss list is configured in a configuration (e.g., PUCCH-config or PUCCH-PowerControl); and/or (iii) pathlossReferenceRSList-r16 where, for example, the first pathloss list is pathlossReferenceRSList-r16 or pathlossReferenceRSList1-r18, the second pathloss list is pathlossReferenceRSList-r18 or pathlossReferenceRSList2-r18, and/or the first pathloss list and/or the second pathloss list is configured in a configuration (e.g., SRS-ResourceSet).

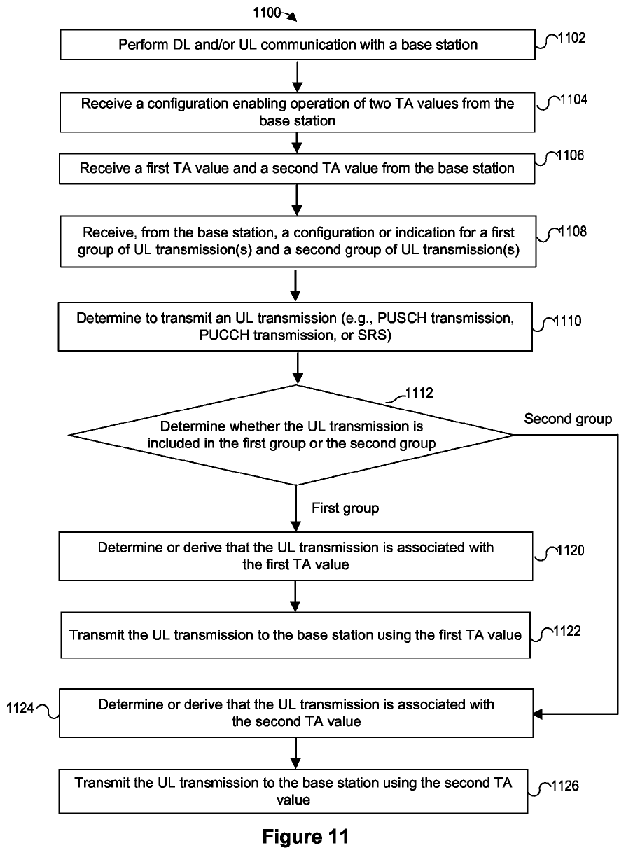

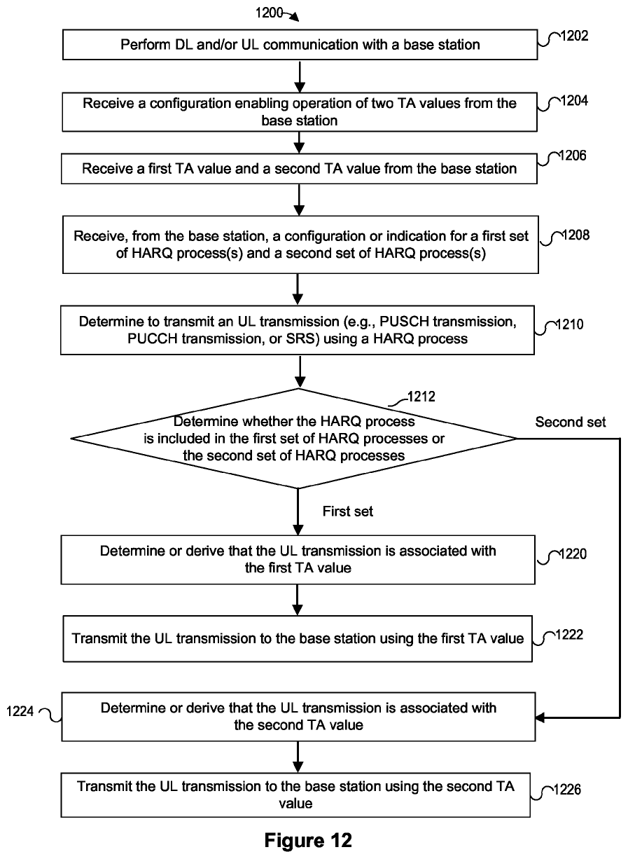

Turning next to FIG. 11, a UE (e.g., the UE 102) implements an example method 1100 to determine which TA value (e.g., the first TA value or the second TA value) to apply when transmitting a UL transmission.

The method 1100 begins at block 1102. Blocks 1102, 1104, 1106, 1120, 1122, 1124, and 1126 are similar to blocks 702, 704, 706, 720, 722, 724, and 726. At block 1108, the UE receives, from the base station, a configuration that configures or an indication that indicates a first group of UL transmission(s) and a second group of UL transmission(s). At block 1110, the UE determines to transmit a UL transmission (e.g., PUSCH transmission, PUCCH transmission, or SRS). At block 1112, the UE determines whether the UL transmission is included in the first group or the second group. If the UE determines that the UL transmission is included in the first group, the flow proceeds to block 1120. If the UE determines that the UL transmission is included in the second group, the flow proceeds to block 1124.

Similar to methods 600-1000, more detailed descriptions of elements of the method 1100 are generally detailed above.

In some cases, the base station configures for or indicates to the UE a first group. In some implementations, the first group comprises one or more UL channel(s) or UL RS(s). In some implementations, the first group comprises one or more ID(s) of UL channel(s) or UL RS(s).

In some cases, the base station configures for or indicates to the UE a second group. In some implementations, the second group comprises one or more UL channel(s) or UL RS(s). In some implementations, the second group comprises one or more ID(s) of UL channel(s) or UL RS(s).

In some implementations, the first group is associated with or includes the first TA value or an ID of the first TA value. In some implementations, the first group is associated with or includes the first TAG or an ID of the first TAG. In some implementations, the first group is associated with or includes the first TAT or an ID of the first TAT. In some implementations, the first group is associated with or includes the first TRP or the first TRP identifier and/or identifier value.

In some implementations, the second group is associated with or includes the second TA value or an ID of the second TA value. In some implementations, the second group is associated with or includes the second TAG or an ID of the second TAG. In some implementations, the second group is associated with or includes the second TAT or an ID of the second TAT. In some implementations, the second group is associated with or includes the second TRP or the second TRP identifier and/or identifier value.

In some cases, the UE determines that (i) the UL transmission is transmitted by applying the first TA value or (ii) the UL transmission is associated with the first TA value, if or when the UE determines that the UL transmission is associated with or comprised in the first group, or the base station configures or indicates that the UL transmission is associated with or comprised in the first group.

In some cases, the UE determines that (i) the UL transmission is transmitted by applying the second TA value or (ii) the UL transmission is associated with the second TA value, if or when the UE determines that the UL transmission is associated with or comprised in the second group, or the base station configures or indicates that the UL transmission is associated with or comprised in the second group.

In some implementations, in cases where the UL transmission is a PUSCH (with dynamically scheduled UL grant or configured UL grant), the first group and/or the second group are a PUSCH resource group. For example, the first group is a PUSCH resource group and the second group is another PUSCH resource group.

In some implementations, in cases where the UL transmission is a PUSCH with configured UL grant, the first group and/or the second group are a PUSCH group. In some implementations, the first group and/or the second group are or are modified from configuredGrantConfigToAddModList-r16. For example, the first group is a PUSCH group configured from configuredGrantConfigToAddModList-r16 or configuredGrantConfigToAddModList-r18 and the second group is another PUSCH group configured from configuredGrantConfigToAddModList-r16 or configuredGrantConfigToAddModList-r18.

In some implementations, in cases where the UL transmission is a PUCCH, the first group and/or the second group are a PUCCH group. In some implementations, the first group and/or the second group are or are modified from PUCCH-ResourceGroup-r16. For example, the first group is a PUCCH group configured from PUCCH-ResourceGroup-r16 or PUCCH-ResourceGroup-r18 and the second group is another PUCCH group configured from PUCCH-ResourceGroup-r16 or PUCCH-ResourceGroup-r18.

In some implementations, in cases where the UL transmission is an SRS, the first group and/or the second group are an SRS group or an SRS resource set. In some implementations, the first group and/or the second group are one of the following or is modified from one of the following: (i) srs-ResourceToAddModList, (ii) srs-PosResourceToAddModList-r16, (iii) SRS-ResourceSet or srs-ResourceIdList, and/or (iv) SRS-PosResourceSet or srs-PosResourceIdList-r16. For example, the first group is an SRS resource set and the second group is another SRS resource set.

Turning next to FIG. 12, a UE (e.g., the UE 102) implements an example method 1200 to determine which TA value (e.g., the first TA value or the second TA value) to apply when transmitting a UL transmission.

The method 1200 begins at block 1202. Blocks 1202, 1204, 1206, 1220, 1222, 1224, and 1226 are similar to blocks 702, 704, 706, 720, 722, 724, and 726. At block 1208, the UE receives, from the base station, a configuration or indication for a first set of HARQ processes and a second set of HARQ processes. At block 1210, the UE determines to transmit a UL transmission (e.g., PUSCH transmission, PUCCH transmission, or SRS) using a HARQ process. At block 1212, the UE determines whether the HARQ process is included in the first set of HARQ processes or the second set of HARQ processes. If the UE determines the HARQ process is included in the first set of HARQ processes, the flow proceeds to block 1220. If the UE determines the HARQ process is included in the second group, the flow proceeds to block 1224.

Similar to methods 600-1100, more detailed descriptions of elements of the method 1200 are generally described above.

In some cases, the base station configures for or indicates to the UE a first set of HARQ process. In some cases, the UE derives a first set of HARQ process.

In some implementations, the first set of HARQ process is associated with one of the following: (i) the first TA value or an ID of the first TA value, (ii) the first TAG or an ID of the first TAG, (iii) the first TAT or an ID of the first TAT, and/or (iv) the first TRP or the first TRP identifier and/or identifier value. In some implementations, the association of the first set of HARQ process is performed by DCI signal, MAC-CE, or RRC message.

In some cases, the base station configures for or indicates to the UE a second set of HARQ process. In some cases, the UE derives a second set of HARQ process.

In some implementations, the second set of HARQ process is associated with one of the following: (i) the second TA value or an ID of the second TA value, (ii) the second TAG or an ID of the second TAG, (iii) the second TAT or an ID of the second TAT, and/or (iv) the second TRP or the second TRP identifier and/or identifier value. In some implementations, the association of the second set of HARQ process may be done by DCI signal, MAC-CE, or RRC message.

In some cases, the UE determines that (i) the UL transmission is transmitted by applying the first TA value or (ii) the UL transmission is associated with the first TA value, if or when the UE determines that the UL transmission is associated with or transmitted via a HARQ process included in the first set of HARQ process, or the base station configures or indicates that the UL transmission is associated with or transmitted via a HARQ process included in the first set of HARQ process.

In some cases, the UE may determines that (i) the UL transmission is transmitted by applying the second TA value or (ii) the UL transmission is associated with the second TA value, if or when the UE determines that the UL transmission is associated with or transmitted via a HARQ process included in the second set of HARQ process, or the base station configures or indicates that the UL transmission is associated with or transmitted via a HARQ process included in the second set of HARQ process.

More descriptions which can be applied for some cases (e.g., scenarios in FIG. 5A-5E) are described below.

In some cases, the UE transmits a first capability report to the base station. In some implementations, the first capability report indicates at least one of the following: (i) whether the UE can support one serving cell as belonging to or included in more than one TAG at the same time, (ii) whether the UE can support more than one TA values that are maintained or operated in one serving cell, and/or (iii) whether the UE can support multiple-TA operations (e.g., two TA values) under an M-TRP scenario (e.g., M-DCI M-TRP or S-DCI M-TRP).

In some cases, the UE transmits a second capability report to the base station. In some implementations, given that no TAG is configured for multiple TA operation, the second capability report indicates the maximum number of TAG supported by the UE. In some implementations, the second capability report is supportedNumberTAG.

In some cases, the UE transmits a third capability report to the base station. In some implementations, given that all TAGs are configured for multiple TA operation (e.g., two TA values), the third capability report indicates at least one of the following: (i) the maximum number of TAG supported by the UE, where (a) one serving cell with a multiple-TA feature is associated with or included in two TAGs, where each of the two TAGs is associated with only one TA value or TAT, and/or (b) the number is at least two if the UE supports that more than one TA value is maintained or operated in one serving cell, indicated in the first capability report; and/or (ii) the maximum number of TAG supported by the UE, where (a) one serving cell with a multiple-TA feature is associated with or included in one TAG, where the TAG is associated with more than one TA value or TAT (e.g., two TA values or two TATs), and/or (b) the number is at least one if the UE supports that more than one TA value is maintained or operated in one serving cell, indicated in the first capability report. In some implementations, the third capability report is a UE capability different from supportedNumberTAG. In some implementations, the fourth capability report is supportedNumberTAG-2TA. In some implementations, if the third capability report is absent or not transmitted, the UE does not support that more than one TA value is maintained or operated in one serving cell. In some such cases, the third capability report and the first capability report are the same.

In some cases, the UE transmits a fourth capability report to the base station. In some implementations, the fourth capability report indicates the maximum number of TAGs supported by the UE or the maximum number of TAG pairs supported by the UE. In some implementations, one TAG pair contains two TAGs configured for multiple-TA operation. In some implementations, given that at least one TAG is configured for multiple TA operation (e.g., two TA values), the fourth capability report indicates at least one of the following: (i) the maximum number of TAG supported by the UE, where (a) one serving cell with a multiple-TA feature is associated with or included in two TAGs, where each of the two TAGs is associated with only one TA value or TAT, (b) the number counts all TAGs configured for single-TA operation and multiple-TA operation, (c) the number counts all TAGs configured for only multiple-TA operation, and/or (d) the number is at least two if the UE supports that more than one TA value is maintained or operated in one serving cell, indicated in the first capability report; (ii) the maximum number of TAG pairs supported by the UE, where (a) one serving cell with multiple-TA feature is associated with or included in two TAGs, where each of the two TAGs is associated with only one TA value or TAT, (b) the number counts only TAGs configured for multiple-TA operation, and/or (c) the number is at least one if the UE supports that more than one TA value is maintained or operated in one serving cell, indicated in the first capability report; (iii) the maximum number of TAGs supported by the UE, where (a) one serving cell with a multiple-TA feature is associated with or included in one TAG, where the TAG is associated with more than one TA value or TAT (e.g., two TA values or two TATs), (b) the number counts all TAGs configured for single-TA operation and multiple-TA operation, (c) the number counts all TAGs configured for only multiple-TA operation, and/or the number is at least one if the UE supports that more than one TA values is maintained or operated in one serving cell, indicated in the first capability report; and/or (iv) a supported combination of numbers of TAGs configured for multiple-TA operation (denoted as M) and a number of TAGs configured for single-TA operation (denoted as N), where candidates of (M, N) may be (1, 2), (1, 3), (2, 0), (3, 0), (0, 1), (0,2), (0,3), (0,4), etc. In some implementations, the fourth capability report is a UE capability different from supportedNumberTAG. In some implementations, the fourth capability report is supportedNumberTAG-2TA. In some implementations, if the fourth capability report is absent or not transmitted, the UE does not support that more than one TA value is maintained or operated in one serving cell. In some such cases, the fourth capability report and the first capability report are the same.

In some cases, the maximum number of TAGs or TAG pairs indicated in the second, third, or fourth capability report is affected by at least one of the following: (i) whether the number is for NR CA, NR-DC, and/or (NG)EN-DC/NE-DC; (ii) whether the band combination comprised of more than one band entry (i.e., inter-band or intra-band non-contiguous band combination); and/or (iii) the number of band entry

In some cases, the UE receives an indication or configuration, from the base station, of a signal. In some implementations, the signal is an RRC IE (e.g., featurePriorities or featurePriorities-r18). In some implementations, the signal indicates priority values for features supported by the UE. In some implementations, the signal indicates priority values of at least one of the following features: (i) multiple TA operation (or 2 TA operation), (ii) RedCap (i.e., Reduced Capability), (iii) Slicing (or Network Slicing or slice group), (iv) SDT (i.e., Small Data Transmission), (v) MSG3 repetition, (vi) MSGB repetition, and/or (vii) CovEnh (i.e., Coverage Enhancement).

In some implementations, the base station indicates, to the UE, one or more preamble combinations. In some implementations, one preamble combination includes one or more RA preambles and/or RA resources. In some implementations, a preamble combination is used for, indicated for, or associated with one or more features supported by the UE. In some implementations, a preamble combination is indicated by an RRC IE FeatureCombinationPreambles. In some implementations, which features map to or are associated with the preamble combination are indicated by an RRC IE featureCombination, which is configured in the FeatureCombinationPreambles.

In some implementations, the indicated priority values are used to determine which preamble combination the UE uses or applies for a feature when a feature maps to or is associated with more than one preamble combination. In some implementations, a lower value means a higher priority. In some implementations, the base station does not indicate the same priority value for more than one feature. In some implementations, the base station indicates a priority value for all features that map to at least one preamble combination or FeatureCombinationPreambles.

In some cases, the UE performs an RA procedure for a feature using a preamble combination determined to use or apply for the feature. In some implementations, the UE performs an RA procedure for a feature using RA preambles and/or RA resources in the preamble combination determined to use or apply for the feature. In some implementations, the UE does not perform an RA procedure for a feature using RA preambles and/or RA resources not in the preamble combination determined to use or apply for the feature.

It is noted that throughout this disclosure, “a TA value is expired” can refer to at least one of the following: (i) a TA value is not synchronized, (ii) a TA value is outdated, and/or (iii) a TA value is uplink time aligned.

It is noted that throughout this disclosure, a neighboring cell can refer to or be replaced with at least one of the following: (i) a non-serving cell, (ii) a cell with PCI different than a PCI of the serving cell, and/or (iii) a TRP associated with a PCI different from a PCI of the serving cell.

It is noted that throughout this disclosure, a joint TCI state can refer to or be replaced with at least one of the following: (i) a beam applicable for both DL and UL transmission (e.g., DL or UL channel, DL or UL RS, etc.), (ii) a spatial filter for transmission and/or reception, (iii) a spatial parameters for transmission and/or reception, (iv) a spatial relationship for transmission and/or reception, and/or (v) a spatial assumption for transmission and/or reception.

It is noted that throughout this disclosure, a joint TCI state can refer to or be replaced with a common TCI state or a unified TCI state.

It is noted that throughout the document, a UL TCI state can refer to or be replaced with at least one of the following: (i) a UL beam, (ii) a spatial relation, (iii) a spatial transmitting filter, (iv) a transmission precoder, (v) spatial parameters, and/or (vi) a spatial relationship.

It is noted that throughout this disclosure, a DL TCI state may be referred to or replaced with at least one of the following: (i) a TCI applicable for DL channel(s) or RS(s), (ii) a TCI associated with quasi co-location (QCL) type-D, (iii) a QCL assumption, (iv) a DL beam, (v) a spatial receiving filter, (vi) spatial parameters, (vii) a spatial relationship, and/or (viii) a spatial assumption.

It is noted that throughout this disclosure, a TCI pool (e.g., joint TCI pool, UL TCI pool, DL TCI pool) may be referred to or stand for a (RRC) configuration or a list, which may include or contain one or more TCI (index). It is noted that throughout this disclosure, “a TCI” can be referred to or replaced with “a TCI state”. It is noted that throughout this disclosure, “a TCI pool” can be referred to or replaced with “a TCI state pool”.

It is noted that throughout this disclosure, the UE can have one or more of the following attributes or behaviors. The following attributes or behaviors of the UE can also imply associated attributes or behaviors of a base station: (i) The UE is configured with and/or served by the base station in a serving cell. (ii) The UE is configured to communicate with the base station in the serving cell. (iii) The UE is configured with one or more serving cells by the base station, which can include the serving cell. (iv) The UE is activated or indicated, by the base station, to activate one or more serving cells, which can include the serving cell. (v) The UE has configured and/or indicated, by the base station, one or more BWP. The UE has indicated and/or configured, by the BS, a BWP in the serving cell. (a) In some implementations, the BWP is activated as an active BWP; (b) in some implementations, the BWP refers to an active BWP; (c) in some implementations, the BWP is an active DL BWP; (d) in some implementations, the BWP is an active UL BWP; (e) in some implementations, the BWP is an initial BWP; (f) in some implementations, the BWP is a default BWP; (g) in some implementations, the BWP is a dormant BWP. (vi) The UE is in one of RRC_CONNECTED state, RRC_INACTIVE state, or RRC_IDLE State.

It is noted that throughout this disclosure, an expression of “X/Y” may include meaning of “X or Y”. It is noted that throughout this disclosure, an expression of “X/Y” may include meaning of “X and Y”. It is noted that throughout this disclosure, an expression of “X/Y” may include meaning of “X and/or Y”. It is noted that throughout this disclosure, an expression of “(A) B” or “B (A)” may include concept of “only B”. It is noted that throughout this disclosure, an expression of “(A) B” or “B (A)” may include concept of “A+B” or “B+A”.

It is noted that throughout this disclosure, a panel could mean that an antenna (port) group or an antenna (port) set. There may be more than one DL/UL beams associated with one panel. When one transmitting node (UE or BS) is performing a transmission via a panel, only one beam associated with the panel could be used to perform the transmission. For a transmitter comprising more than one panels, e.g., two panels, it may happen that two beams associated with the two panels respectively are used to perform a transmission.

It is noted that throughout this disclosure, a TRP identifier could mean or be referred to as a (candidate) value of a TRP identifier. The first TRP identifier could be a first candidate value of a TRP identifier or a first TRP identifier value. The second TRP identifier could be a second candidate value of a TRP identifier or a second TRP identifier value.

It is noted that throughout this disclosure, a panel identifier could mean or be referred to as a (candidate) value of a panel identifier. The first panel identifier could be a first candidate value of a panel identifier or a first panel identifier value. The second panel identifier could be a second candidate value of a panel identifier or a second panel identifier value.

It is noted that throughout this disclosure, a TCI field could mean or be referred to as a field used or applied or repurposed to indicate one or more TCI states.

It is noted that throughout this disclosure, “joint mode” or “joint TCI state mode” could mean at least one of the following: (i) TCI field(s) or indicated TCI state(s) in a DCI format refer/map to one of joint TCI state pool, DL TCI state pool, or UL TCI state pool; and/or (ii) beam indication(s) or indicated TCI state(s) are applied for both transmitting UL transmission and/or receiving DL transmission.

It is noted that throughout this disclosure, “separate mode” or “separate TCI state mode” could mean at least one of the following: (i) TCI field(s) or indicated TCI state(s) in a DCI format refer/map to one of joint TCI state pool, DL TCI state pool, or UL TCI state pool; and/or (ii) beam indication(s) or indicated TCI state(s) are applied either for (only) transmitting UL transmission or (only) receiving DL transmission.

It is noted that throughout this disclosure, “UL mode” or “UL-only TCI state mode” could mean at least one of the following: (i) TCI field(s) or indicated TCI state(s) in a DCI format refer/map to UL TCI state pool (joint TCI state pool); and/or (ii) beam indication(s) or indicated TCI state(s) are applied for (only) transmitting UL transmission.

It is noted that throughout this disclosure, “DL mode” or “DL-only TCI state mode” could mean at least one of the following: (i) TCI field(s) or indicated TCI state(s) in a DCI format refer/map to DL TCI state pool (joint TCI state pool); and/or (ii) beam indication(s) or indicated TCI state(s) are applied for (only) receiving DL transmission.

It is noted that throughout this disclosure, when a procedure or description is related to a serving cell, it may mean the procedure or description is related to an active (DL/UL) BWP in the serving cell.

It is noted that throughout this disclosure, “a TA timer” or “a TAT” may be referred to or be replaced with “a TA alignment timer”.

It is noted that some or all of the foregoing or the following embodiments could be jointly combined or formed to be a new or another one embodiment.

It is noted that the foregoing or the following embodiments can be used to solve at least (but not limited to) the issue(s) or scenario(s) mentioned in this disclosure.

The list of examples below reflects a variety of the embodiments explicitly contemplated.

Example 1. A method in a UE comprises receiving, from a RAN, a configuration including a first TA value and a second TA value for use in a serving cell; receiving, from the RAN, a spatial indication for communicating a signal between the UE and the RAN; selecting a TA value from among the first TA value and the second TA value based on the spatial indication; and communicate the signal with the RAN using the selected TA value.

Example 2. The method of example 1, further comprising receiving, from the RAN, an indication that use of multiple TA values in the serving cell is enabled.

Example 2. The method of example 1, further comprising, prior to receiving the spatial indication: receiving a configuration including an indication that a first spatial indication corresponds to the first TA value, and that a second spatial indication corresponds to the second TA value; wherein the selecting of the TA value includes determining whether the received spatial indication is the first spatial indication or the second spatial indication.

Example 3. The method of example 1, further comprising, prior to receiving the spatial indication: receiving a configuration including an indication that a first spatial indication corresponds to a first TAT, and that a second spatial indication corresponds to a second TAT; wherein the selecting of the TA value includes determining whether the received spatial indication is the first spatial indication or the second spatial indication.

Example 4. The method of claim 1, further comprising, prior to receiving the spatial indication: receiving a configuration including an indication that a first spatial indication corresponds to a first TRP, and that a second spatial indication corresponds to a second TRP; wherein the selecting of the TA value includes determining whether the received spatial indication is the first spatial indication or the second spatial indication.

Example 5. A method in a RAN, the method comprising: transmitting, to UE, a configuration including a first TA value and a second TA value for use in a serving cell; transmitting, from the RAN, a spatial indication for communicating a signal between the UE and the RAN, the spatial indication associated with one of the first TA value or the second TA value; and communicating the signal with the UE in accordance with the spatial indication.

Example 6. The method of example 5, further comprising: transmitting, to the UE, an indication that use of multiple TA values in the serving cell is enabled.

Example 7. The method of example 5, further comprising, prior to transmitting the spatial indication: transmitting, to the UE, a configuration including an indication that a first spatial indication corresponds to the first TA value, and that a second spatial indication corresponds to the second TA value.

Example 8. The method of example 5, further comprising, prior to transmitting the spatial indication: transmitting, to the UE, a configuration including an indication that a first spatial indication corresponds to a first TA timer (TAT), and that a second spatial indication corresponds to a second TAT.

Example 9. The method of example 5, further comprising, prior to transmitting the spatial indication: transmitting, to the UE, a configuration including an indication that a first spatial indication corresponds to a first TRP, and that a second spatial indication corresponds to a second TRP.

The following additional considerations may apply to the foregoing and the following discussions.

It is noted that any two or more than two of the foregoing or the following paragraphs, (sub)-bullets, points, actions, or claims described in each method/embodiment/implementation may be combined logically, reasonably, and properly to form a specific method.

It is noted that any sentence, paragraph, (sub)-bullet, point, action, or claim described in each of the foregoing or the following method(s)/embodiment(s)/implementation(s) may be implemented independently and separately to form a specific method. Dependency, e.g., “based on”, “more specifically”, “where” or etc., in the following method(s)/embodiment(s)/implementation(s) is just one possible embodiment which would not restrict the specific method.

It is noted that, some or all of the following terminology and assumption may be used hereafter: (i) Base station (BS): a network central unit or a network node in NR which is used to control one or multiple TRPs which are associated with one or multiple cells. Communication between a base station and TRP(s) is via fronthaul. A base station may be referred to as a central unit (CU), eNB, gNB, or NodeB. (ii) Transmission and reception point (TRP): a transmission and reception point provides network coverage and directly communicates with UEs. A TRP may be referred to as distributed unit (DU) or network node. (iii) Cell: a cell is composed of one or multiple associated TRPs (i.e., coverage of the cell is composed of coverage of all associated TRP(s)). One cell is controlled by one base station. A cell may be referred to as a TRP group (TRPG). (iv) Serving beam: a serving beam for a UE is a beam generated by a network node (e.g., TRP), which is configured to be used to communicate with the UE (e.g., for transmission and/or reception). (v) Candidate beam: a candidate beam for a UE is a candidate of a serving beam. A serving beam may or may not be candidate beam.

A user device in which the techniques of this disclosure can be implemented (e.g., the UE 102) can be any suitable device capable of wireless communications such as a smartphone, a tablet computer, a laptop computer, a mobile gaming console, a point-of-sale (POS) terminal, a health monitoring device, a drone, a camera, a media-streaming dongle or another personal media device, a wearable device such as a smartwatch, a wireless hotspot, a femtocell, or a broadband router. Further, the user device in some cases may be embedded in an electronic system such as the head unit of a vehicle or an advanced driver assistance system (ADAS). Still further, the user device can operate as an internet-of-things (IOT) device or a mobile-internet device (MID). Depending on the type, the user device can include one or more general-purpose processors, a computer-readable memory, a user interface, one or more network interfaces, one or more sensors, etc.

Certain embodiments are described in this disclosure as including logic or a number of components or modules. Modules may can be software modules (e.g., code stored on non-transitory machine-readable medium) or hardware modules. A hardware module is a tangible unit capable of performing certain operations and may be configured or arranged in a certain manner. A hardware module can comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. The decision to implement a hardware module in dedicated and permanently configured circuitry, or in temporarily configured circuitry (e.g., configured by software) may be driven by cost and time considerations.

When implemented in software, the techniques can be provided as part of the operating system, a library used by multiple applications, a particular software application, etc. The software can be executed by one or more general-purpose processors or one or more special-purpose processors.

1. A method in a user equipment (UE), the method comprising:
receiving, from a radio access network (RAN), a configuration including a first timing advance (TA) value and a second TA value for use in a serving cell;
receiving, from the RAN, a transmission configuration indication (TCI) state for communicating a signal between the UE and the RAN;
selecting a TA value from among the first TA value and the second TA value based on the TCI state; and
communicating the signal with the RAN using the selected TA value.

2. The method of claim 1, wherein:
the first TA value is associated with a first transmission-reception point (TRP) of a node in the RAN; and
the second TA value is associated with a second TRP of the node in the RAN.

3. The method of claim 1, wherein the TCI state is an uplink (UL) TCI state.

4. The method of claim 1, wherein the TCI state is a joint TCI state.

5. The method of claim 1, wherein:
the first TA value is associated with a first TA group (TAG); and
the second TA value is associated with a second TAG.

6. The method of claim 5, further comprising, prior to receiving the TCI state:
receiving a configuration including an indication that a first TCI state corresponds to the first TAG, and that a second TCI state corresponds to the second TAG;
wherein the selecting of the TA value includes determining whether the received TCI state is the first TCI state or the second TCI state.

7. The method of claim 6, wherein the configuration is included in a radio resource control (RRC) message.

8. A method in a radio access network (RAN), the method comprising:
transmitting, to a user equipment (UE), a configuration including a first timing advance (TA) value and a second TA value for use in a serving cell;
transmitting, from the RAN, a transmission configuration indication (TCI) state for communicating a signal between the UE and the RAN, the TCI state associated with one of the first TA value or the second TA value; and
communicating the signal with the UE in accordance with the TCI state.

9. The method of claim 8, wherein:
a first TCI state corresponds to a first TAG with which the first TA value is associated;
a second TCI state corresponds to a second TAG with which the second TA value is associated; and
wherein the transmitted TCI state is one of the first TCI state or the second TCI state.

10. The method of claim 9, further comprising, prior to the transmitting of the TCI state:
configuring the UE with a first association between the first TCI state and the first TAG, and a second association between the second TCI state and the second TAG.

11. The method of claim 10, wherein the configuring of the UE includes:
including the first association in a first RRC message; and
including the second association in a second RRC message.

12. The method of claim 10, wherein the configuring of the UE includes:
including the first association and the second association in a shared RRC message.

13. The method of claim 1, wherein the communicating of the signal with the UE includes:
receiving an uplink (UL) transmission from the UE.

14. A user equipment (UE) comprising:
a transceiver configured to communicate with a radio interface; and
processing hardware, the UE configured to:
receive, from a radio access network (RAN), a configuration including a first timing advance (TA) value and a second TA value for use in a serving cell;
receive, from the RAN, a transmission configuration indication (TCI) state for communicating a signal between the UE and the RAN, select a TA value from among the first TA value and the second TA value based on the TCI state, and communicate the signal with the RAN using the selected TA value.

15. The UE of claim 14, wherein:
the first TA value is associated with a first transmission-reception point (TRP) of a node in the RAN; and
the second TA value is associated with a second TRP of the node in the RAN.

16. The UE of claim 14, wherein the TCI state is an uplink (UL) TCI state.

17. The UE of claim 14, wherein the TCI state is a joint TCI state.

18. The UE of claim 14, wherein:
the first TA value is associated with a first TA group (TAG); and
the second TA value is associated with a second TAG.

19. The UE of claim 18, further configured to, prior to receiving the TCI state:
receive a configuration including an indication that a first TCI state corresponds to the first TAG, and that a second TCI state corresponds to the second TAG;
wherein the selecting of the TA value includes determining whether the received TCI state is the first TCI state or the second TCI state.

20. The UE of claim 19, wherein the configuration is included in a radio resource control (RRC) message.
